(19) United States
(12) Patent Application Publication
(10) Pub. No.: US 2026/0214656 A1
(43) Pub. Date: Jul. 23, 2026

(54) TECHNIQUES FOR ADAPTING COMMUNICATION PARAMETERS FOR BANDWIDTH PART

(71) Applicant: QUALCOMM Incorporated, San Diego, CA (US)

(72) Inventors: Diana MAAMARI, San Diego, CA (US); Gabi SARKIS, San Diego, CA (US); Mostafa KHOSHNEVISAN, San Diego, CA (US); Yan ZHOU, San Diego, CA (US); Muhammad Sayed Khairy ABDELGHAFFAR, San Jose, CA (US); Yu ZHANG, San Diego, CA (US)

(21) Appl. No.: 19/027,856

(22) Filed: Jan. 17, 2025

(51) Int. Cl. H04W 72/0457; H04B 7/06; H04W 72/231; H04W 76/20

(52) U.S. Cl. CPC H04W 72/0457; H04B 7/0626; H04W 72/231; H04W 76/20

(57) ABSTRACT

Various aspects of the present disclosure generally relate to wireless communication. In some aspects, a user equipment (UE) may receive, a bandwidth part (BWP) configuration that configures a BWP, the BWP including at least a first subband having a first set of resource blocks (RBs) and a second subband having a second set of RBs, wherein the BWP configuration is associated with a set of transmission configuration indication (TCI) states, a set of channel state information reference signal (CSI-RS) resources, or both. The UE may receive, from the network node, a message activating the first subband for communications. The UE may communicate with the network node in accordance with at least one TCI state of the set of TCI states or at least one CSI-RS resource of the set of CSI-RS resources that are valid for the first subband. Numerous other aspects are described.

### FIELD OF THE DISCLOSURE

Aspects of the present disclosure generally relate to wireless communication and specifically relate to techniques, apparatuses, and methods associated with adapting communication parameters for a bandwidth part.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples, a user equipment (UE) may be configured with one or more bandwidth parts (BWPs) for communications with a serving cell of the UE. A BWP is a subset of contiguous resource blocks (RBs) within the set of RBs associated with a carrier, and a carrier may be partitioned into multiple BWPs (e.g., four BWPs). The ability to partition the carrier into BWPs may provide flexibility and efficient usage of the bandwidth associated with the carrier.

### SUMMARY

Some aspects described herein relate to a user equipment (UE) for wireless communication. The UE may include one or more memories and one or more processors coupled to the one or more memories. The one or more processors may be configured to receive, from a network node, a bandwidth part (BWP) configuration that configures a BWP, the BWP including at least a first subband having a first set of resource blocks (RBs) and a second subband having a second set of RBs, wherein the BWP configuration is associated with a set of transmission configuration indication (TCI) states, a set of channel state information reference signal (CSI-RS) resources, or both, valid for at least one of the first subband or the second subband. The one or more processors may be configured to receive, from the network node, a message activating the first subband for communications. The one or more processors may be configured to communicate with the network node in accordance with at least one TCI state of the set of TCI states or at least one CSI-RS resource of the set of CSI-RS resources that are valid for the first subband and the message activating the first subband.

Some aspects described herein relate to a method of wireless communication performed by a UE. The method may include receiving, from a network node, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The method may include receiving, from the network node, a message activating the first subband for communications. The method may include communicating with the network node in accordance with at least one TCI state of the set of TCI states or at least one CSI-RS resource of the set of CSI-RS resources that are valid for the first subband and the message activating the first subband.

Some aspects described herein relate to a non-transitory computer-readable medium that stores a set of instructions for wireless communication by a UE. The set of instructions, when executed by one or more processors of the UE, may cause the UE to receive, from a network node, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The set of instructions, when executed by one or more processors of the UE, may cause the UE to receive, from the network node, a message activating the first subband for communications. The set of instructions, when executed by one or more processors of the UE, may cause the UE to communicate with the network node in accordance with at least one TCI state of the set of TCI states or at least one CSI-RS resource of the set of CSI-RS resources that are valid for the first subband and the message activating the first subband.

Some aspects described herein relate to an apparatus for wireless communication. The apparatus may include means for receiving, from a network node, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The apparatus may include means for receiving, from the network node, a message activating the first subband for communications. The apparatus may include means for communicating with the network node in accordance with at least one TCI state of the set of TCI states or at least one CSI-RS resource of the set of CSI-RS resources that are valid for the first subband and the message activating the first subband.

Some aspects described herein relate to a network node for wireless communication. The network node may include one or more memories and one or more processors coupled to the one or more memories. The one or more processors may be configured to transmit, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The one or more processors may be configured to transmit, to the UE, a message activating the first subband for communications. The one or more processors may be configured to communicate with the UE in accordance with at least one TCI state of the set of TCI states valid for the first subband or at least one CSI-RS resource of the set of CSI-RS resources valid for the first subband and the message activating the first subband.

Some aspects described herein relate to a method of wireless communication performed by a network node. The method may include transmitting, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The method may include transmitting, to the UE, a message activating the first subband for communications. The method may include communicating with the UE in accordance with at least one TCI state of the set of TCI states valid for the first subband or at least one CSI-RS resource of the set of CSI-RS resources valid for the first subband and the message activating the first subband.

Some aspects described herein relate to a non-transitory computer-readable medium that stores a set of instructions for wireless communication by a network node. The set of instructions, when executed by one or more processors of the network node, may cause the network node to transmit, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The set of instructions, when executed by one or more processors of the network node, may cause the network node to transmit, to the UE, a message activating the first subband for communications. The set of instructions, when executed by one or more processors of the network node, may cause the network node to communicate with the UE in accordance with at least one TCI state of the set of TCI states valid for the first subband or at least one CSI-RS resource of the set of CSI-RS resources valid for the first subband and the message activating the first subband.

Some aspects described herein relate to an apparatus for wireless communication. The apparatus may include means for transmitting, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The apparatus may include means for transmitting, to the UE, a message activating the first subband for communications. The apparatus may include means for communicating with the UE in accordance with at least one TCI state of the set of TCI states valid for the first subband or at least one CSI-RS resource of the set of CSI-RS resources valid for the first subband and the message activating the first subband.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of using beams for communications between a network node and a user equipment (UE), in accordance with the present disclosure.

FIG. 4 is a diagram illustrating examples of channel state information reference signal beam management procedures, in accordance with the present disclosure.

FIG. 5 is a diagram illustrating an example of a bandwidth part (BWP), in accordance with the present disclosure.

FIG. 6 is a diagram illustrating an example of adapting communication parameters for a BWP, in accordance with the present disclosure.

FIG. 7 is a diagram illustrating an example of adapting communication parameters for a BWP, in accordance with the present disclosure.

FIG. 8 is a diagram of an example associated with adapting communication parameters for a BWP, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of wireless communication networks will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a user equipment (UE) may be configured with one or more bandwidth parts (BWPs) for communications with a serving cell of the UE. For example, an active BWP may define the operating bandwidth of the UE 120 within the operating bandwidth of the serving cell, and the UE may perform communications with a frequency (e.g., a set of frequencies) defined by the BWP. Accordingly, the wireless communication network may support flexible assignments of a frequency spectrum for the UE that is different from (e.g., a subset of) an operating bandwidth of a serving cell (e.g., a carrier bandwidth). Consequently, BWPs may support adaptation of communication parameters more quickly and with lower signaling overhead relative to configuring parameters for the entire operating bandwidth.

In some examples, communication parameters (e.g., radio resource control (RRC) parameters) may be organized and configured per BWP (i.e., for each BWP), which may simplify the configuration and adaptation of communication parameters for the UE relative to configuring parameters for the operating bandwidth. For example, downlink parameters such as physical downlink control channel (PDCCH) parameters, physical downlink shared channel (PDSCH) parameters, downlink semi-persistent scheduling parameters, radio link monitoring parameters, and/or other downlink communication parameters may be configured for a BWP. Additionally, or alternatively, uplink parameters such as physical uplink control channel (PUCCH) parameters, physical uplink shared channel (PUSCH) parameters, sounding reference signal (SRS) parameters, uplink configured grant parameters, beam failure recovery parameters, or other suitable uplink communication parameters may be configured for a BWP. Despite the flexibility of configuring parameters per BWP, however, there may be increased UE complexity and overhead as the UE may reconfigures a large number of registers with every BWP switch associated with updating corresponding parameters for the BWP.

In some examples, the wireless communication network may support light adaptation techniques, which may support the adaptation of some communication parameters (e.g., bandwidth, number of active antennas, maximum rank, scheduling timeline, scheduling offset, or search space periodicity) for the UE without necessitating a BWP switch, which may be associated with larger overhead and delays. For example, light adaptation techniques may support the adaptation of communication parameters without reprogramming the UE with different DCI configurations and while allowing the UE to decode DCI using a previous configuration, even when the UE is experiencing out-of-service conditions, as DCI size or fields may remain the same. Additionally, light adaptation techniques may allow same-slot scheduling, in contrast to BWP switching, which may be associated with scheduling delays. Accordingly, UE complexity and overhead may be reduced, as the UE may avoid reconfiguring a large amount of registers when performing a BWP switch.

For example, to enable light adaptation techniques in which communication parameters are adapted without a full BWP switch, one or more subbands (e.g., sub-BWPs) may be configured within a BWP for the UE. For example, a first subband (e.g., a broad subband) may be configured to encompass an entire bandwidth associated with the BWP, and a second subband (e.g., a narrow subband, such as a lower-frequency portion) may include a portion of the bandwidth associated with the BWP (e.g., a limited bandwidth). In some cases, such as in low-traffic scenarios, the UE may be configured to operate using the second subband (e.g., the narrow subband), which may restrict the operating bandwidth of the UE and thereby reduce power consumption associated with monitoring a larger bandwidth (e.g., or a higher frequency bandwidth). When heavier data traffic is to be experienced by the UE, for example, a network node may activate the first bandwidth for the UE, and the UE may communicate using the first subband (e.g., the broad subband), which may facilitate a higher communication throughput associated with the heavier data traffic.

In some examples, each subband of the BWP may be associated with an identifier, and the identifier may be indicated via DCI. For example, at least one cyclic redundancy check (CRC) bit (e.g., of the DCI) may be masked in accordance with the identifier of the active subband. A DCI size may be independent of the active subband, which may allow the UE to decode DCI even in out-of-service conditions. For example, the network node may transmit DCI in accordance with the first subband, and the out-of-service UE operating accordance to the second subband (e.g., due to a previously missed DCI) may still decode the DCI and may indicate to the network node that the UE is experiencing out-of-service conditions. In some examples, while the DCI size may remain the same for each subband, the UE may interpret the DCI differently depending on which subband is active. For example, one or more fields may be interpreted differently (e.g., according to different bit formats), while the DCI size may remain the same.

Accordingly, the DCI may still convey different information using DCI fields that depend on the active subband while being decodable regardless of which subband is used for reception of the DCI by the UE. For example, the UE may determine that the UE is experiencing out-of-service conditions based on the DCI including an identifier corresponding to an active subband that does not match the subband in use by the UE. Therefore, light adaptation techniques may reduce reconfiguration procedures for the UE by maintaining a constant DCI size between different subbands of a BWP (e.g., relative to changing DCI sizes between subbands). In some cases, however, other communication parameters may change between subbands, which may cause some reconfiguration to be performed at the UE when switching between subbands. Consequently, the UE and the network node may experience transmission overhead and latency associated with reconfiguring the communication parameters when the UE is indicated to switch active subbands.

Various aspects relate generally to adapting communication parameters for a BWP. Some aspects more specifically relate to a BWP configuration that indicates a transmission configuration indication (TCI) configuration and/or a channel state information (CSI) configuration for the BWP, and parameters within the TCI configuration and/or the CSI configuration may be adapted based on an active subband of the BWP. In some aspects, the TCI configuration may indicate a plurality of TCI states common for each subband of the BWP, and a validity indication may be used to indicate which TCI states of the plurality of TCI states are valid for each subband. For example, a mask (e.g., a bitmap) may be used to validate or invalidate at least one TCI state of the plurality of TCI states for at least one of the subbands. In some examples, a DCI bit size associated with activating a TCI state may be selected in accordance with the number of TCI states common for each subband of the BWP. In some aspects, when the UE operates using a subband having the lowest number of valid TCI states (e.g., a narrow subband), a DCI field for a DCI indicating a TCI state may be zero padded to a size that supports the number of valid TCI states for the subband having the highest number of valid TCI states. Additionally, or alternatively, a table (e.g., an RRC table) may be configured for each subband, and the DCI field may indicate a codepoint that maps to one or more TCI states in accordance with the table for the active subband. In some aspects, the CSI configuration may indicate a plurality of CSI reference signal (CSI-RS) resources for the first subband (e.g., the broad subband), and the UE may exclude CSI-RS resources of the plurality of CSI-RS resources that are outside a bandwidth for the second subband (e.g., the narrow subband) when operating using the second subband. Additionally, or alternatively, the CSI configuration may include a semi-static CSI configuration indicating CSI-RS resources for each subband of the BWP.

Particular aspects of the subject matter described in this disclosure can be implemented to realize one or more of the following potential advantages. In some examples, the described techniques can be used to configure communication parameters for a plurality of subbands of a BWP while avoiding baseband reconfiguration of the communication parameters when switching between subbands. For example, by signaling a TCI configuration indicating a plurality of TCI states common for all subbands of a BWP, the UE may be configured to select valid TCI states when switching subbands, thereby reducing transmission overhead and latency associated with receiving and applying an additional TCI configuration. Additionally, by signaling a CSI configuration indicating CSI-RS resources for a broadest subband, the UE may be configured with CSI-RS resources for narrower subbands of a BWP, thereby reducing transmission overhead and latency associated with receiving an additional CSI configuration for a narrower subband. Accordingly, transmission overhead and latency associated with switching an active subband may be reduced by avoiding additional reconfiguration of communication parameters.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

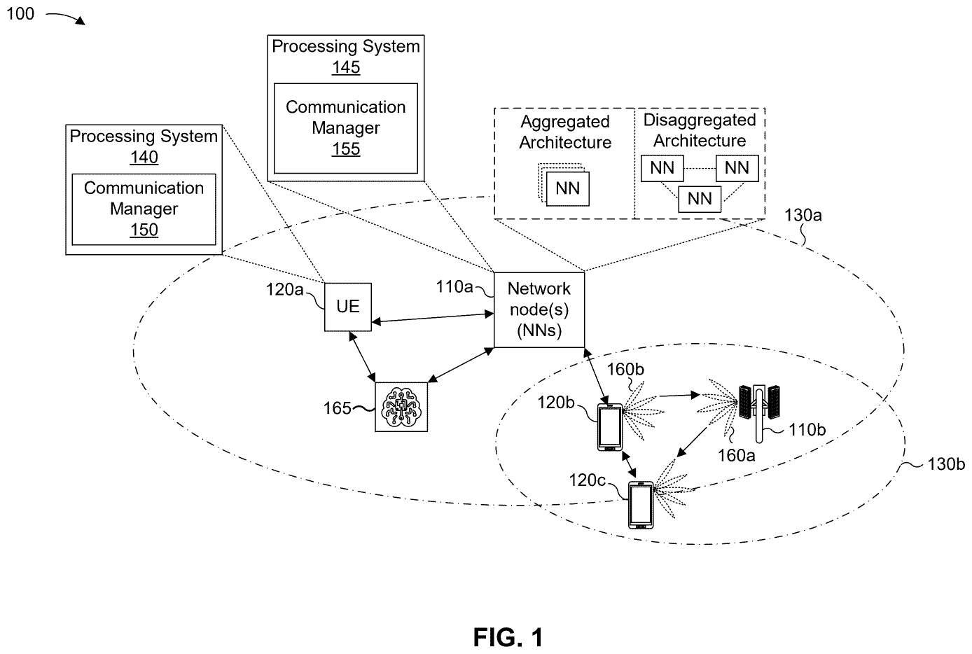

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in

one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also may output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

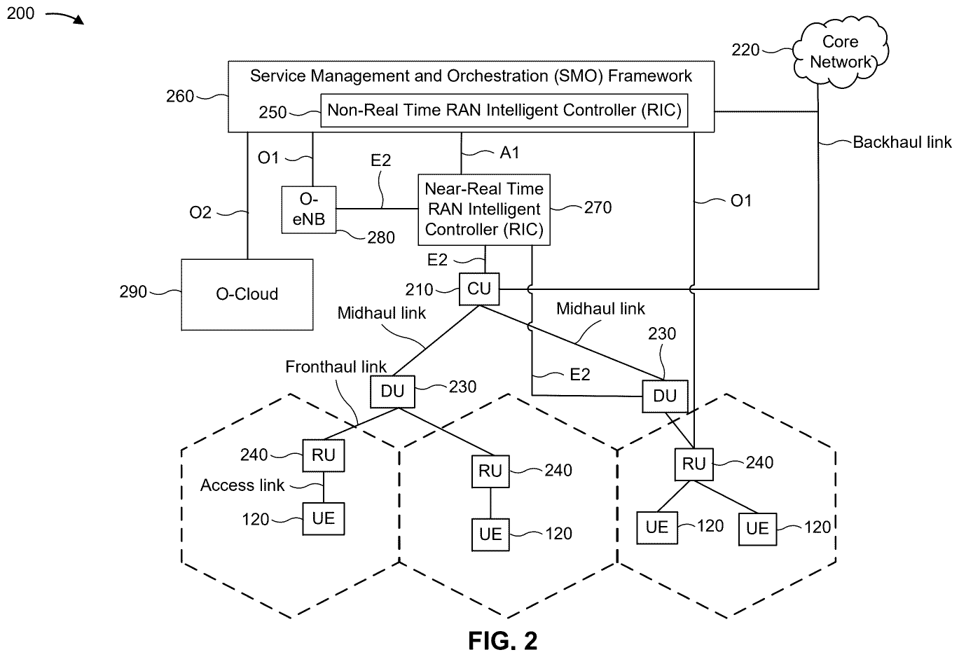

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower-layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

In some aspects, a BWP may be configured as a subset or a part of a total or full component carrier bandwidth and generally forms or encompasses a set of contiguous RBs within the full component carrier bandwidth. For example, within the carrier bandwidth, a BWP may start at a specifically configured RB and may span a specific set of consecutive RBs. In some examples, a UE 120 may be configured with up to four downlink BWPs and up to four uplink BWPs for each serving cell. To reduce UE power consumption, only one BWP in the downlink and one BWP in the uplink may be active at a given time on an active serving cell under typical operation. The active BWP may be used by the UE 120 to perform communications with the serving cell while all other BWPs with which the UE 120 is configured are deactivated. On deactivated BWPs, the UE 120 may refrain from transmitting or receiving any communications.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include PUCCHs, and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a TCI state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

In some examples, the network node 110 may provide the UE 120 with a configuration of TCI states that indicate or correspond to beams that may be used by the UE 120, such as for receiving one or more communications via a physical channel. For example, the network node 110 may indicate (for example, using DCI) an activated TCI state to the UE 120, which the UE 120 may use to generate a beam for receiving one or more communications via the physical channel. A TCI state information element (sometimes referred to as a TCI state herein) may indicate particular information associated with a beam. For example, the TCI state information element may indicate a TCI state identification (for example, a tci-StateID), a QCL type (for example, a qcl-Type1, qcl-Type2, qcl-TypeA, qcl-TypeB, qcl-TypeC, or a qcl-TypeD, among other examples), a cell identification (for example, a ServCellIndex), a bandwidth part identification (bwp-Id), or a reference signal identification, such as a CSI-RS identification (for example, an NZP-CSI-RS-ResourceId or an SSB-Index, among other examples).

In some examples, the network node 110 may provide the UE 120 with a configuration for a tracking reference signal, which may be used as a proxy for some channels. For example, the tracking reference signal may be used as a source for some QCL types (e.g., QCL Type A, or QCL Type D). In some cases, a TRS configuration may be indicated by network node 110 and to the UE 120 on a per-BWP basis. Additionally, or alternatively, the TCI state configuration may be configured to the UE 120 per BWP.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive, from a network node 110, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband; receive, from the network node 110, a message activating the first subband for communications; and communicate with the network node in accordance with at least one TCI state of the set of TCI states or at least one CSI-RS resource of the set of CSI-RS resources that are valid for the first subband and the message activating the first subband. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband; transmit, to the UE 120, a message activating the first subband for communications; and communicate with the UE 120 in accordance with at least one TCI state of the set of TCI states valid for the first subband or at least one CSI-RS resource of the set of CSI-RS resources valid for the first subband and the message activating the first subband. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower-layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

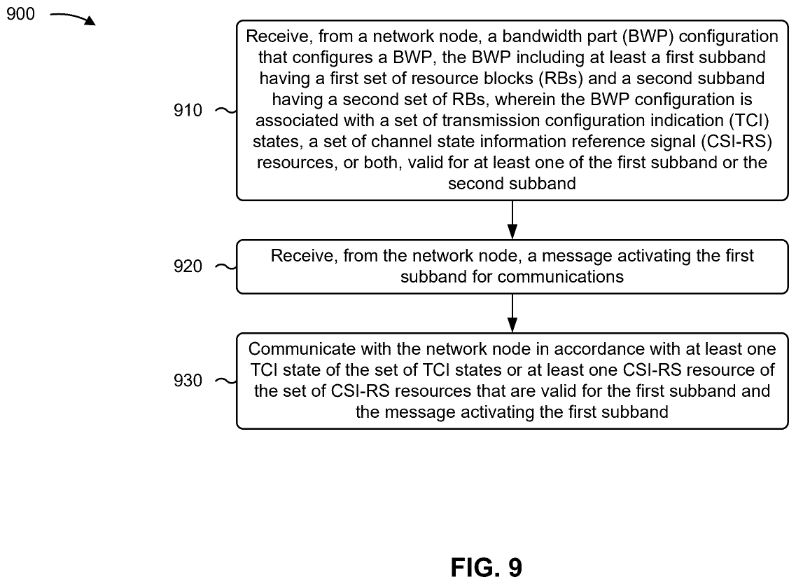

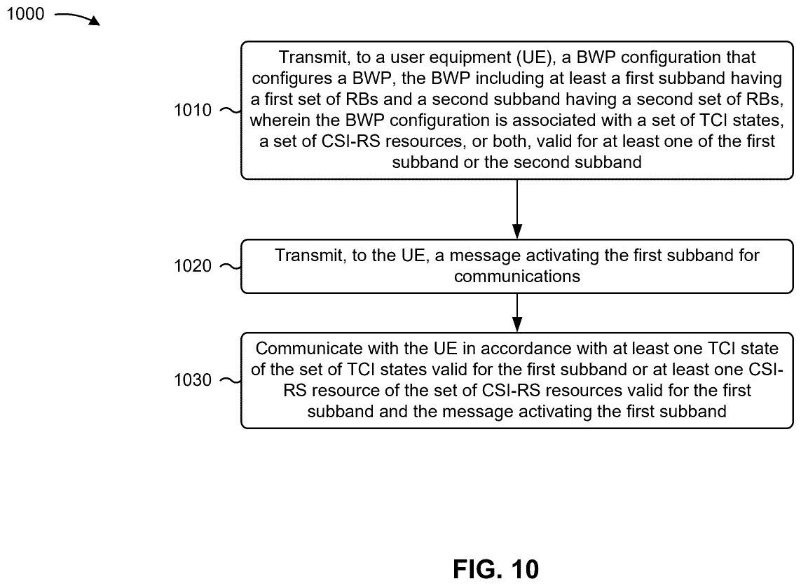

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with adapting communication parameters for a BWP, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

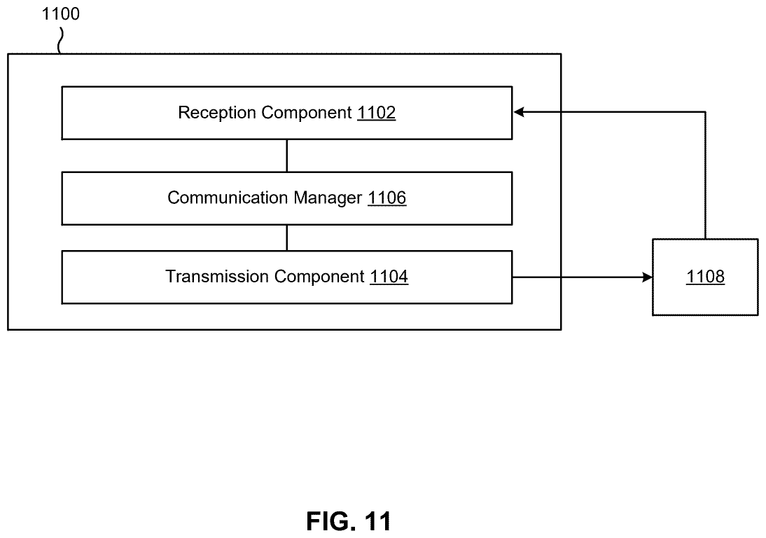

In some aspects, the UE 120 includes means for receiving, from a network node 110, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband; means for receiving, from the network node, a message activating the first subband for communications; and/or means for communicating with the network node in accordance with at least one TCI state of the set of TCI states or at least one CSI-RS resource of the set of CSI-RS resources that are valid for the first subband and the message activating the first subband. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11, and/or a transmission component (for example, transmission component 1104 depicted and described in connection with FIG. 11), among other examples.

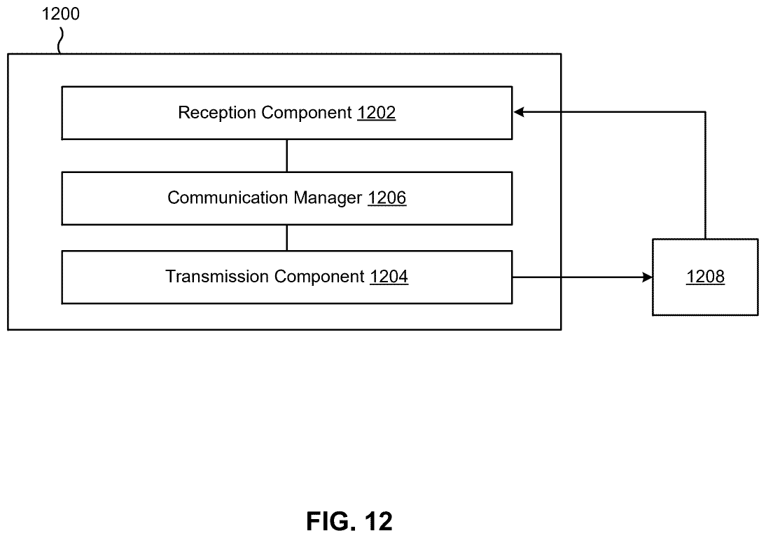

In some aspects, the network node 110 includes means for transmitting, to a UE 120, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband; means for transmitting, to the UE 120, a message activating the first subband for communications; and/or means for communicating with the UE in accordance with at least one TCI state of the set of TCI states valid for the first subband or at least one CSI-RS resource of the set of CSI-RS resources valid for the first subband and the message activating the first subband. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

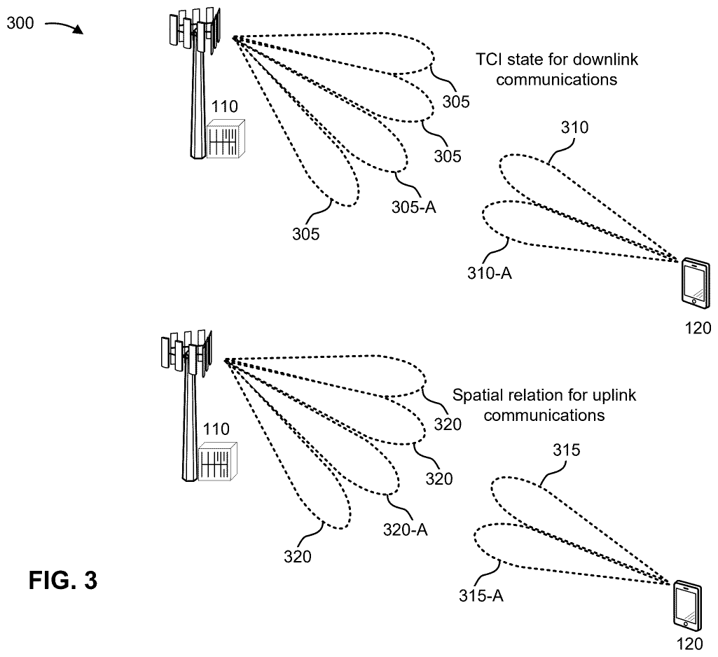

FIG. 3 is a diagram illustrating an example 300 of using beams for communications between a network node and a UE, in accordance with the present disclosure. As shown in FIG. 3, a network node 110 and a UE 120 may communicate with one another.

The network node 110 may transmit to a UE 120 located within a coverage area of the network node 110. The network node 110 and the UE 120 may be configured for beamformed communications, where the network node 110 may transmit in the direction of the UE 120 using a directional NN transmit beam (e.g., a BS transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 305.

The UE 120 may attempt to receive downlink transmissions via one or more UE receive beams 310, which may be configured using different beamforming parameters at receive circuitry of the UE 120. The UE 120 may identify a particular NN transmit beam 305, shown as NN transmit beam 305-A, and a particular UE receive beam 310, shown as UE receive beam 310-A, that provide relatively favorable performance (for example, that have a best channel quality of the different measured combinations of NN transmit beams 305 and UE receive beams 310). In some examples, the UE 120 may transmit an indication of which NN transmit beam 305 is identified by the UE 120 as a preferred NN transmit beam, which the network node 110 may select for transmissions to the UE 120. The UE 120 may thus obtain and maintain a beam pair link (BPL) with the network node 110 for downlink communications (for example, a combination of the NN transmit beam 305-A and the UE receive beam 310-A), which may be further refined and maintained in accordance with one or more established beam refinement procedures.

A downlink beam, such as an NN transmit beam 305 or a UE receive beam 310, may be associated with a transmission configuration indication (TCI) state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each NN transmit beam 305 may be associated with a synchronization signal block (SSB), and the UE 120 may indicate a preferred NN transmit beam 305 by transmitting uplink transmissions in resources of the SSB that are associated with the preferred NN transmit beam 305. A particular SSB may have an associated TCI state (for example, for an antenna port or for beamforming). The network node 110 may, in some examples, indicate a downlink NN transmit beam 305 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the network node 110 indicating an NN transmit beam 305 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 315.

The network node 110 may receive uplink transmissions via one or more NN receive beams 320 (e.g., BS receive beams). The network node 110 may identify a particular UE transmit beam 315, shown as UE transmit beam 315-A, and a particular NN receive beam 320, shown as NN receive beam 320-A, that provide relatively favorable performance (for example, that have a best channel quality of the different measured combinations of UE transmit beams 315 and NN receive beams 320). In some examples, the network node 110 may transmit an indication of which UE transmit beam 315 is identified by the network node 110 as a preferred UE transmit beam, which the network node 110 may select for transmissions from the UE 120. The UE 120 and the network node 110 may thus obtain and maintain a BPL for uplink communications (for example, a combination of the UE transmit beam 315-A and the NN receive beam 320-A), which may be further refined and maintained in accordance with one or more established beam refinement procedures. An uplink beam, such as a UE transmit beam 315 or an NN receive beam 320, may be associated with a spatial relation. A spatial relation may indicate a directionality or a characteristic of the uplink beam, similar to one or more QCL properties, as described above.

In accordance with aspects as described herein, the network node 110 may transmit, and the UE 120 may receive, a BWP configuration that indicates a TCI configuration for each subband (e.g., sub-BWPs) of a BWP. In some aspects, the TCI configuration may indicate a common resource pool including a plurality of TCI states, and a mask may be used to indicate which TCI states are valid for an active subband. For example, the mask may be indicated via an RRC message and may include a bitmap having a bit corresponding to each TCI states. In some aspects, a first value of a respective bit may indicate that a corresponding TCI state is valid for a subband of the BWP, and a second value of a respective bit may indicate that a corresponding TCI state is not valid for the subband. Accordingly, the TCI configuration may indicate TCI states for each subband of a BWP without relying on signaling a new TCI configuration when switching active subbands for the UE 120, thereby reducing transmission overhead and latency associated with subband switching.

As indicated above, FIG. 3 is provided as an example. Other examples may differ from what is described with respect to FIG. 3.

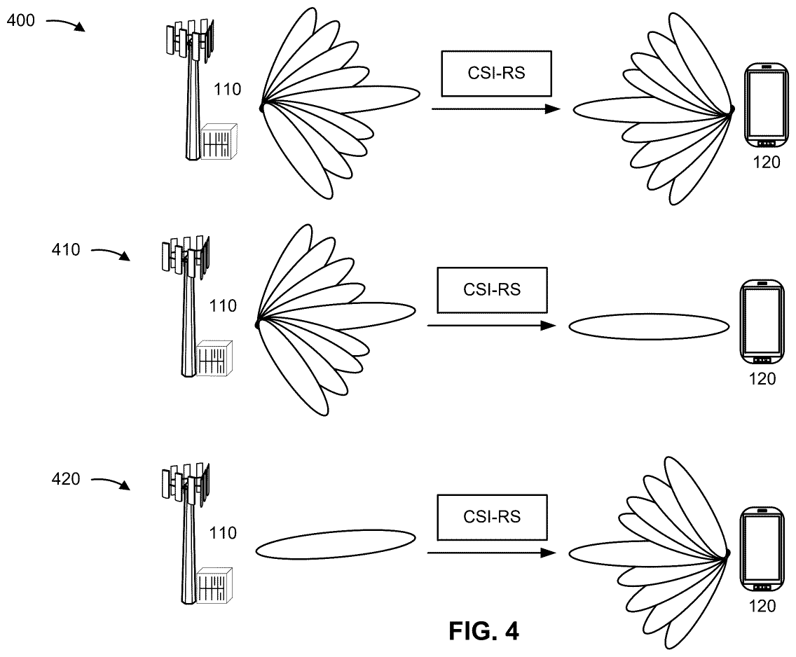

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network node 110 in a wireless network (e.g., wireless communication network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS multiple times within the same CSI-RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use SSBs for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P4 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In accordance with aspects as described herein, the network node 110 may transmit, and the UE 120 may receive, a BWP configuration that indicates a CSI configuration for each subband (e.g., sub-BWPs) of a BWP. In some aspects, the CSI configuration may indicate a common resource pool including a plurality of CSI-RS resources, and a mask may be used to indicate which CSI-RS resources are valid for an active subband. Additionally, or alternatively, the CSI configuration may indicate a plurality of CSI-RS resources for a broad subband of the BWP that may include an entire bandwidth associated with the BWP. When operating using a narrow subband that includes a portion of the bandwidth associated with the BWP, the UE 120 may exclude CSI-RS resources of the plurality that are outside the portion of the bandwidth. Additionally, or alternatively, the CSI configuration may include a semi-static CSI configuration indicating periodic CSI-RS resources for each subband of the BWP. Accordingly, the CSI configuration may indicate CSI-RS resources for each subband of the BWP without relying on signaling a new CSI configuration when switching active subbands for the UE 120, thereby reducing transmission overhead and latency associated with subband switching.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

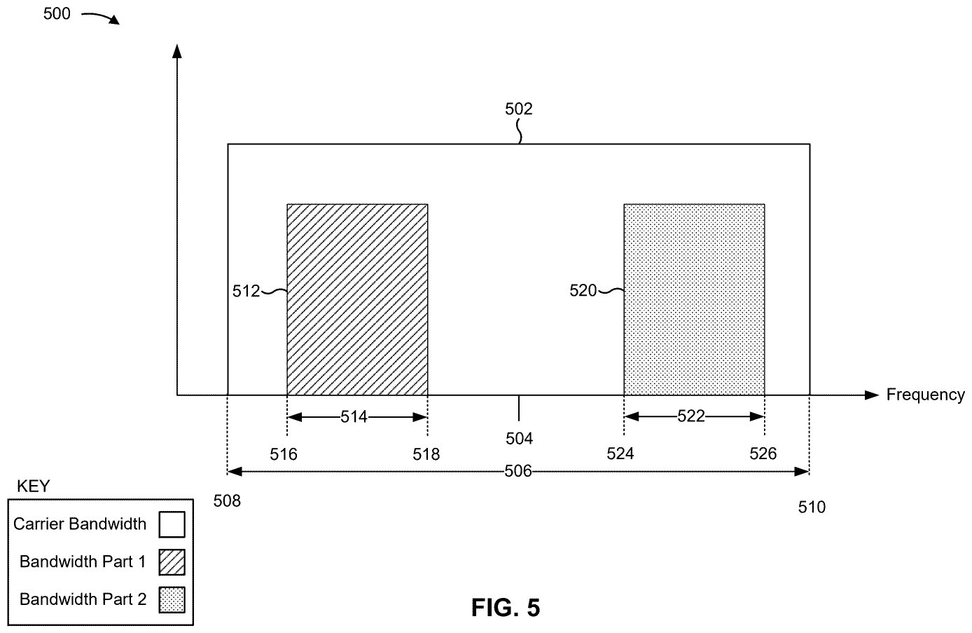

FIG. 5 is a diagram illustrating an example 500 of a BWP, in accordance with the present disclosure.

In some aspects, a wireless communication channel, alternatively referred to as a “carrier”, may be based at least in part on a center frequency, a frequency bandwidth, and or a set of RBs. To illustrate, a carrier 502 may be based at least in part on a center frequency 504 (e.g., a carrier frequency) and a frequency bandwidth 506. The frequency bandwidth 506 of the carrier 502 may be based at least in part on a first edge frequency 508 and a second edge frequency 510. Each RB of the carrier may include a group of REs that are characterized by a frequency partition and a time partition. Accordingly, the set of RBs associated with the carrier 502 may collectively span a bandwidth (e.g., the frequency bandwidth 506) and time duration.

“Bandwidth part” (or “BWP”) may denote a subset of contiguous RBs (and/or REs) within the set of RBs associated with a carrier, and a carrier may be partitioned into multiple BWPs (e.g., four). The ability to partition the carrier into BWPs may provide flexibility and efficient usage of the bandwidth associated with the carrier. To illustrate, the frequency bandwidth 506 may span 100 MHz and may be referred to as a wideband channel. Some UEs 120, such as an IoT device and/or a reduced capacity (RedCap) device, may lack capabilities that support wideband communications. For example, an IoT device may lack a transceiver with capabilities to transmit and/or receive a wideband signal. Alternatively or additionally, the IoT device may lack a processor with capabilities to process digital samples associated with the wideband signal in real-time. Accordingly, a network node 110 may partition a carrier into one or more BWPs for communicating with the IoT and/or other types of UEs 120. To illustrate, the network node 110 may select and/or configure a first BWP 512 (shown by a diagonal line hash pattern) within the carrier 502 based at least in part on a frequency bandwidth 514, a first frequency edge 516, and a second frequency edge 518. The network node 110 may select and/or configure a second BWP 520 (shown by a dotted pattern) within the carrier 502 based at least in part on a frequency bandwidth 522, a first frequency edge 524, and a second frequency edge 526. The network node 110 may select a preconfigured BWP (e.g., defined by a communication standard) and/or may dynamically configure a BWP (e.g., dynamically select a bandwidth and/or a frequency edge).

Although the example 500 shows the first BWP 512 and the second BWP 520 as having equal bandwidths and being positioned symmetrically within the carrier 502, other examples may include BWPs in a same carrier that have different characteristics (e.g., frequency bandwidths). To illustrate, the first BWP 512 may be configured with a larger bandwidth relative to the second BWP 520 based at least in part on the first BWP 512 being used for a higher data throughput relative to the second BWP 520. The second BWP 520 may be configured with a smaller bandwidth relative to the first BWP 512 based at least in part on reducing a transmission size and/or processing associated with the transmission in order to reduce power consumption at a UE 120. Thus, a network node 110 may configure and/or select a BWP based at least in part on a variety of factors, such as UE 120 power requirements, data throughput, and/or spectrum usage. For instance, the network node 110 may configure and/or select a BWP associated with a frequency bandwidth of 5 MHz based at least in part on using the BWP for communications with a RedCap UE 120 and/or an IoT with limited capabilities, as described above.

In some aspects, only a single BWP of the multiple BWPs may be active per transmission direction at a given time, such as a single active BWP for uplink (UL) transmissions and/or a single active BWP for DL transmissions. Alternatively or additionally, the single active BWP may be associated with bi-directional transmissions, such as time division duplex transmissions that share a same frequency for UL and DL transmissions based at least in part on time partitioning. Accordingly, a network node 110 may direct a UE 120 to switch from using a first BWP as an active BWP to using a second BWP as the active BWP. To illustrate, the UE 120 may utilize an initial BWP when operating in a radio resource control idle (RRC_IDLE) mode and switch to a different BWP when operating in a radio resource control connected (RRC_CONNECTED) mode. That is, the UE 120 may communicate with the network node 110 by initially using the initial BWP as the active BWP and then switch to using the different BWP as the active BWP.

As described above, a BWP may be a designated part from an overall carrier bandwidth and/or a subset of a total available channel bandwidth for a given carrier. The use of BWPs enables a network node 110 to configure communications with a UE 120 in a manner that increases an overall capacity and/or overall performance of a wireless network (e.g., increased data throughput and/or decreased data transfer latencies within a given time span). At times, a network node 110 may reconfigure a BWP that is used by a UE 120, such as by reconfiguring the BWP to adapt to current network conditions, to meet a QoS requirement, to adapt to communication channel changes (e.g., based at least in part on UE 120 mobility), and/or to adapt to spectrum availability. A BWP switch may be governed by one or more operating criteria, such as a delay operating criterion and/or a timing operating criterion that the network node 110 and/or the UE 120 may be obligated to satisfy in order to operate in a wireless network. For instance, a communication standard may specify the delay operating criterion and/or the timing operating criterion, and the network node 110 and/or the UE 120 may be obligated to meet the delay operating criterion and/or the timing criterion to be compliant with the communication standard and/or to operate in a wireless network that is based at least in part on the communication standard.

To illustrate, the communication standard may specify a switching delay criterion that governs a BWP switching process, and a network node 110 and/or UE 120 involved in the BWP switching process may be obligated to meet and/or fulfill the switching delay. For instance, the UE 120 may be obligated to finalize and/or complete BWP switching within the switching delay. As one example, the UE 120 may experience a transmission/reception delay that is associated with a latency between the network node 110 transmitting a communication that indicates a BWP switch instruction (e.g., in DCI), and the UE 120 receiving the communication. Alternatively, or additionally, the UE 120 may incur a processing delay between receiving and decoding the BWP switching instruction. That is, the UE 120 may experience a time delay between receiving a transmission that indicates a BWP switching instruction and decoding the BWP switching instruction from the transmission. To operate in a wireless network, the UE 120 may be obligated to complete and/or finalize a BWP switch, including a transmission/reception delay and a processing delay in combination with a hardware change and/or hardware settling, within the switching delay criterion.

In some scenarios, a carrier may be partitioned into multiple BWPs, and a first BWP in the carrier may be linked to a second BWP in the carrier. To illustrate, a network node 110 may configure a UE 120 with a set of downlink BWP configurations and a set of uplink BWP configurations within the carrier by indicating the set of downlink BWP configurations and/or a set of uplink BWP configurations in RRC signaling. Each downlink BWP configuration may be associated with a respective index and/or a BWP ID, and the respective index and/or BWP ID may be linked to a respective uplink BWP configuration. That is, a first BWP in the carrier and a second BWP in the carrier may be linked through an association with a same index and/or BWP ID. At a later point in time, the network node 110 may indicate to switch BWPs and/or BWP configurations by indicating an index and/or BWP ID to the UE 120 (e.g., via DCI), which may be referred to as DCI-based BWP switching. Alternatively, or additionally, the network node 110 may configure the UE 120 (e.g., in RRC signaling) to perform timer-based BWP switching that includes the network node 110 configuring a timer value in combination with an index and/or BWP ID for a BWP switch. Based at least in part on expiration of the timer, the UE 120 may perform BWP switching to the BWP indicated by the BWP ID and/or index.

In some cases, the UE 120 may interpret a BWP switch instruction as an instruction to configure all of the linked BWPs. For instance, the UE 120 may receive a BWP switch instruction that indicates to switch a downlink BWP configuration, and the instruction may indicate an index and/or BWP ID of the BWP configuration to use. The UE 120 may interpret the BWP switch instruction as an instruction to switch both a downlink BWP configuration and an uplink BWP configuration based at least in part on the index and/or BWP ID being linked to multiple BWP configurations. The linkage between BWP configurations (e.g., a downlink BWP configuration and an uplink BWP configuration) may be governed by a communication standard. As one example, for unpaired spectrum operation (e.g., an operating environment in which uplink transmissions and downlink transmissions occur in separate, non-overlapping frequency ranges), the communication standard may disallow a configuration in which a center frequency for a downlink BWP configuration is different than a center frequency for an uplink BWP configuration for linked BWP configurations. That is, the communication standard may specify that linked BWP configurations in a same carrier use a same center frequency.

Alternatively, or additionally, the communication standard may specify a blanking duration that is associated with BWP switching (e.g., a DCI-based BWP switching and/or a timer-based BWP switching). “Blanking” may denote a UE 120 ceasing to transmit a signal and/or ceasing to receive a signal via a communication chain, and a blanking duration may be a time span in which the UE 120 performs blanking. For instance, the communication standard may specify to perform blanking on an uplink communication channel and/or blanking on a downlink communication channel for a blanking duration. In some cases, the communication standard may specify different blanking durations for different UE 120 device types and/or based at least in part on a UE 120 capability. A blanking duration may differ from a switching delay, and the UE 120 may perform blanking within the switching delay. The use of blanking may mitigate interference in the BWP that the UE 120 is switching away from.

“Joint BWP switching” may denote a UE 120 reconfiguring each communication chain of multiple communication chains with a respective BWP configuration together and/or during a same switching duration based at least in part on a linkage between the BWP configurations. To illustrate, the UE 120 may reconfigure a first communication chain (e.g., a downlink communication chain and/or a receiver communication chain) using a first BWP configuration and may reconfigure a second communication chain (e.g., an uplink communication chain and/or a transmitter communication chain) using a second BWP configuration that is linked to the first BWP configuration. In some cases, joint BWP switching may result in performance degradation in a wireless system, such as increased data transfer latencies, reduced data throughput, and/or sub-optimal air interface resource usage. For instance, the network node 110 may instruct the UE 120 to perform a BWP switch using a first BWP configuration that the network node 110 selected to be optimized for downlink communications, and the first BWP configuration may be linked to a second BWP configuration that is sub-optimal for uplink communications. As one example, a downlink data traffic pattern may differ from an uplink data traffic pattern, and the network node 110 may select a downlink BWP configuration based at least in part on the downlink data traffic pattern. However, the linked uplink BWP configuration may be sub-optimal for the uplink data pattern and, based at least in part on performing joint BWP switching, the UE 120 may reconfigure a transmitter communication chain and/or an uplink communication chain using the (linked) sub-optimal BWP configuration. The sup-optimal BWP configuration may result in sub-optimal bandwidth usage and/or sub-optimal air interface resource usage by the UE 120 and, consequently, air interface resource waste. As another example, the network node 110 may trigger a BWP switch based at least in part on downlink communications, and the joint BWP switching may unnecessarily introduce a latency in uplink communications that introduces a delay in time-sensitive applications and may result in a failure to meet a time-based operating condition and/or a QoS operating condition.

Various aspects relate generally to configuring a first communication chain for a BWP change without modifying a second communication chain. Some aspects more specifically relate to a UE 120 configuring the first communication chain to use an updated BWP, and maintaining, in parallel, communications on the second communication chain (e.g., not performing blanking on the second communication chain). In some aspects, a UE 120 may transmit UE 120 capability information that indicates support for independently modifying a BWP configuration of a first communication chain that is configured with a first BWP in a carrier without modifying a second communication chain that is configured with a second BWP in the carrier. In some aspects, the first communication chain may be a receiver communication chain (e.g., for processing a downlink signal and/or a first sidelink signal) and the second communication chain may be a transmitter communication (e.g., for processing an uplink signal and/or a second sidelink signal), or vice versa. Based at least in part on indicating support for independently modifying the BWP configuration of the first communication chain without modifying the second communication chain, the UE 120 may receive an instruction to reconfigure the first communication chain to a third BWP in the carrier without modifying the second communication chain. That is, the instruction may indicate to only reconfigure the first communication chain. In some aspects, the UE 120 may use the second communication chain while reconfiguring the first communication chain, resulting in reduced data transfer latencies relative to joint BWP switching.

In some aspects, a network node 110 may receive UE 120 capability information that indicates support for independently modifying a BWP configuration of a first communication chain that is configured with a first BWP in a carrier without modifying a second communication chain that is configured with a second BWP in the carrier. Based at least in part on receiving the indication of the support for independently modifying the BWP configuration of the first communication chain without modifying the second communication chain, the network node 110 may transmit an instruction to reconfigure the first communication chain with a third BWP in the carrier without modifying the second communication chain. That is, the instruction may indicate to only modify the first communication chain and/or may not indicate to modify the second communication chain. In some aspects, the network node 110 may transmit the instruction based at least in part on a scheduling pattern. To illustrate, the network node 110 may leverage an uplink time partition by instructing the UE 120 to reconfigure a downlink communication chain during at least part of the uplink time partition.

Particular aspects of the subject matter described in this disclosure can be implemented to realize one or more of the following potential advantages. In some examples, by using independent BWP switching for multiple communication chains (e.g., instead of using joint BWP switching), the described techniques can be used to enable a network node 110 to leverage a scheduling pattern and instruct a UE 120 to reconfigure a first communication chain during a time partition that is associated with a second communication chain. For example, the network node 110 may instruct a UE 120 to reconfigure a BWP of a downlink communication chain during an uplink time partition (e.g., a time partition in which the downlink communication chain will be unused) to reduce data transfer latencies and/or increase data throughput of the downlink chain (or vice versa). The use of independent BWP switching may also enable the network node 110 to select unlinked BWP configurations for each communication chain used by a UE 120 and/or select respective BWP configurations that are optimized for the communication chain. For instance, the network node 110 may select a first downlink BWP configuration that reduces air interface resource waste based at least in part on a downlink data traffic pattern and/or may select a second BWP configuration (e.g., that is not linked to the first BWP configuration) that reuses air interface resource waste based at least in part on an uplink data traffic pattern. Alternatively, or additionally, the network node 110 may select each BWP configuration to reduce a respective data transfer latency and/or satisfy a QoS operating condition. Mitigating air interface resources waste may reduce data transfer latencies and/or increase data throughput.

As indicated above, FIG. 5 is provided as an example. Other examples may differ from what is described with regard to FIG. 5.

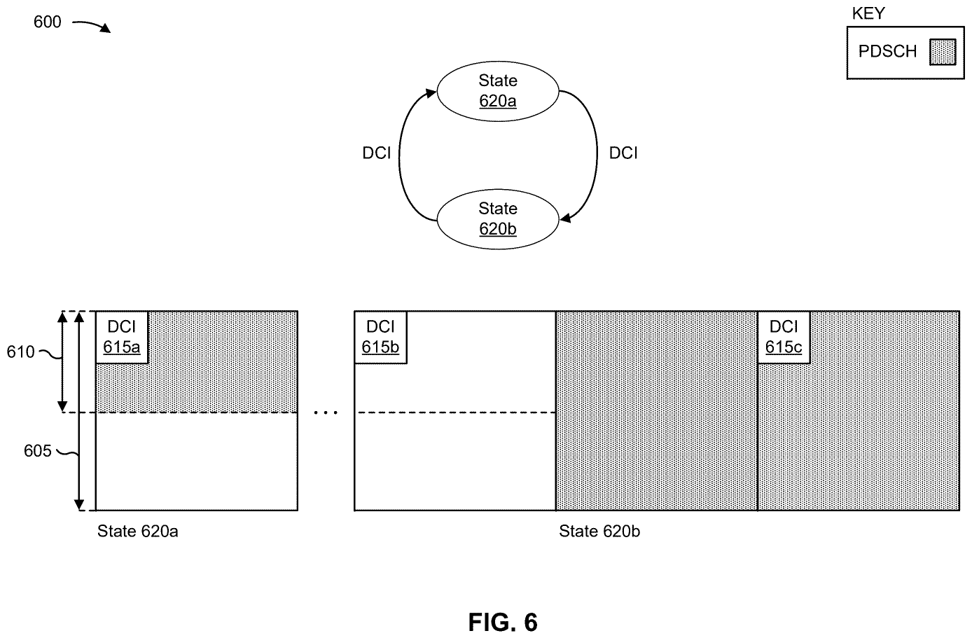

FIG. 6 is a diagram illustrating an example 600 of adapting communication parameters for a BWP, in accordance with the present disclosure. The example 600 illustrates a BWP 605 (e.g., a carrier bandwidth, an active BWP), which may be configured for operations between a UE 120 and a network node 110.

In some examples, the UE 120 and the network node 110 may support light adaptation techniques, which may support the adaptation of some communication parameters for the UE 120 without necessitating a BWP switch. For example, the network node 110 may indicate that the UE 120 is to operate in accordance with a subband 610 (e.g., a limited bandwidth), which may be a subset of the BWP 605. Accordingly, the UE 120 may operate using a smaller frequency range, which may reduce power consumption for the UE 120 without performing a BWP switch that may be associated with larger overhead or timing delays. In some examples, the network node 110 may indicate that the UE 120 is to operate within the subband 610 via DCI.

Additionally or alternatively, light adaptation techniques may support the adaptation of other communication parameters. For example, the UE 120 may be configured with one or more states 620, such as a state 620a or a state 620b, and a state 620 may be activated by the network node 110 via DCI. In some examples, a state may be associated with one or more communication parameters, such as a bandwidth (e.g., the subband 610, or the BWP 605), a number of active antennas, a maximum rank parameter, a scheduling timeline, one or more scheduling offsets (e.g., K0, or minimum/maximum values for the offsets), a search space periodicity, and/or other communication parameters.

For example, the UE 120 may receive the DCI 615 (e.g., the DCI 615a, or a previous DCI), and the DCI 615 may activate the state 620a for the UE 120. Accordingly, the UE 120 may operate using one or more communication parameters associated with the state 620a, such as the subband 610. For example, the UE 120 may monitor for PDSCH messages via the subband 610, thereby reducing power consumption relative to monitoring the BWP 605. In some cases, for example, the UE 120 may be indicated to switch to operating in accordance with the state 620a if traffic (e.g., data traffic) for the UE 120 is relatively low (e.g., below some threshold).

The UE 120 may receive the DCI 615b, which may indicate that the UE 120 is to operate in accordance with the state 620b. For example, the UE 120 may switch to operating using one or more communication parameters associated with the state 620b. In some examples, the UE 120 may communicate in accordance with an entire bandwidth of the BWP 605, and the UE 120 may monitor for PDSCH messages via the BWP 605.

Accordingly, light adaptation techniques may allow the UE 120 to switch operating parameters via DCI, without performing a BWP switch that may be associated with delays. For example, light adaptation techniques may allow for same-slot scheduling for the UE 120 in accordance with communication parameters of a state 620, in contrast to BWP switching which may include scheduling delays (e.g., based on K0 or K2, which may be non-zero).

In some examples, a DCI configuration and/or a DCI size may remain the same between states 620. Consequently, the UE 120 may be able to monitor for and decode DCI 615 in the state 620a or the state 620b, even if the UE 120 is experiencing out-of-service conditions and has missed a previous indication to switch states 620. For example, the network node 110 may transmit DCI 615 in accordance with the state 620a, and the out-of-service UE 120 operating in accordance with the state 620b (e.g., due to a previously missed DCI) may still decode the DCI 615 and may indicate to the network entity node that the UE 120 is experiencing out-of-service conditions. In some examples, while the DCI size may remain the same for each subband, the UE 120 may interpret the DCI differently depending on which subband is active. For example, one or more fields may be interpreted differently (e.g., according to different bit formats), while the DCI size may remain the same. As a result, the UE 120 may attempt to decode the DCI 615 in accordance with a DCI field format corresponding to the active state 620, and the UE 120 may then decode the DCI 615 in accordance with a DCI field format corresponding to the inactive state 620 if the first decoding was unsuccessful.

Accordingly, the DCI 615 may still convey different information using DCI fields that depend on the active subband while being decodable regardless of which subband is used for reception of the DCI 615 by the UE 120. For example, the UE 120 may determine that the UE 120 is experiencing out-of-service conditions based on the DCI 615 including an identifier corresponding to an active subband included in the DCI 615 that does not match the subband in use by the UE 120. Therefore, light adaptation techniques may reduce reconfiguration procedures for the UE 120 by maintaining a constant DCI size between different subbands of a BWP (e.g., relative to changing DCI sizes between subbands).

In some cases, however, other communication parameters may change between subbands, which may cause some reconfiguration to be performed at the UE 120 when switching between states 620. Consequently, the UE 120 and the network node 110 may experience transmission overhead and latency associated with reconfiguring the communication parameters when the UE 120 is indicated to switch active subbands.

In accordance with aspects as described herein, a BWP configuration may indicate a TCI configuration and/or a CSI configuration for the BWP 605, and parameters within the TCI configuration and/or the CSI configuration may be adapted based on an active subband of the BWP 605. In some aspects, the TCI configuration may indicate a plurality of TCI states common for each subband of the BWP, and a validity indication may be used to indicate which TCI states of the plurality of TCI states are valid for each subband. For example, a mask (e.g., a bitmap) may be used to validate or invalidate at least one TCI state of the plurality of TCI states for at least one of the subbands. In some examples, a DCI bit size associated with activating a TCI state may be selected in accordance with the number of TCI states common for each subband of the BWP 605. In some aspects, when the UE 120 operates using a subband having the lowest number of valid TCI states (e.g., a narrow subband), a DCI field for a DCI 615 indicating a TCI state may be zero padded to a size that supports the number of valid TCI states for the subband having the highest number of valid TCI states. Additionally, or alternatively, a table (e.g., an RRC table) may be configured for each subband, and the DCI field may indicate a codepoint that maps to one or more TCI states in accordance with the table for the active subband. In some aspects, the CSI configuration may indicate a plurality of CSI-RS resources for the first subband (e.g., the broad subband), and the UE 120 may exclude CSI-RS resources of the plurality of CSI-RS resources that are outside a bandwidth for the second subband (e.g., the narrow subband) when operating using the second subband. Additionally, or alternatively, the CSI configuration may include a semi-static CSI configuration indicating CSI-RS resources for each subband of the BWP 605.

As indicated above, FIG. 6 is provided as an example. Other examples may differ from what is described with regard to FIG. 6.

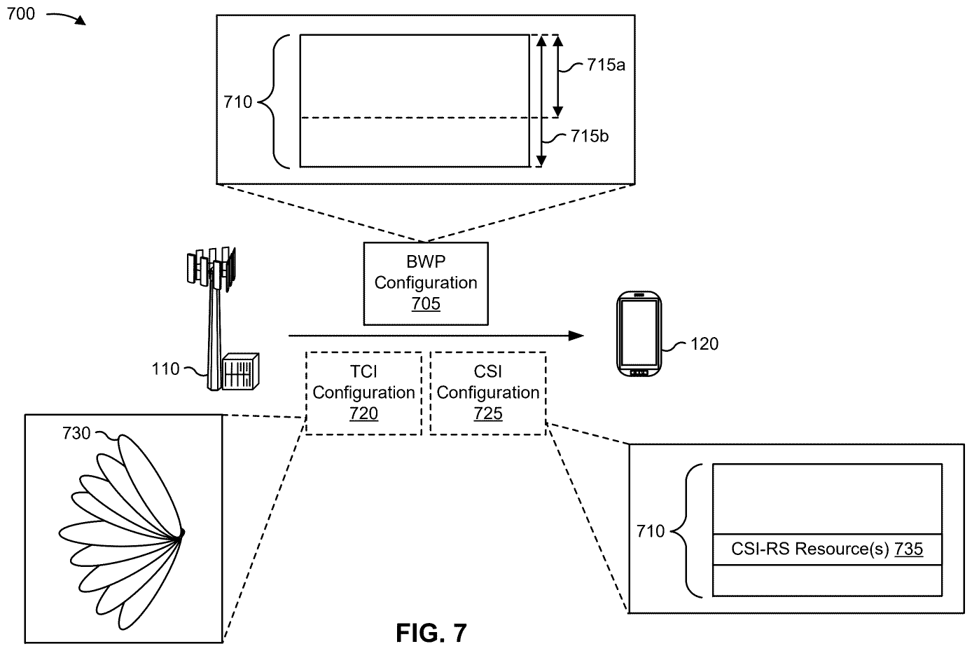

FIG. 7 is a diagram illustrating an example 700 of adapting communication parameters for a BWP, in accordance with the present disclosure. As shown in FIG. 7, example 700 includes communications between a UE 120 and a network node 110. The UE 120 and the network node 110 may communicate via a wireless access link, which may include an uplink and a downlink.

The network node 110 may transmit, and the UE 120 may receive, a BWP configuration 705 that configures a BWP 710. In some examples, the BWP 710 may include a bandwidth (e.g., a frequency bandwidth) that is a subset of an operating bandwidth of a serving cell of the UE 120 (e.g., an operating bandwidth of the network node 110, or a carrier bandwidth), as described herein. In some cases, the BWP 710 may include one or more subbands 715 (e.g., sub-BWPs). For example, the BWP 710 may include a subband 715a (e.g., a narrow subband, or a subband with scheduling restrictions) spanning a first set of RBs, and a subband 715b (e.g., a broad subband, or a subband without scheduling restrictions) spanning a second set of RBs.

In some cases, the first set of RBs corresponding to the subband 715a may correspond to a portion of bandwidth associated with the BWP 710, and the second set of RBs corresponding to the subband 715b may span the entire bandwidth associated with the BWP 710 and may include the first set of RBs. In some examples, the network node 110 may transmit a message activating a subband 715 (e.g., the subband 715a or the subband 715b) for communications between the UE 120 and the network node 110, and the UE 120 may operate using the active subband 715 based on receiving the message. While the example 700 and some aspects described herein relate to a BWP configuration 705 that configures two subbands 715, there may be more than two subbands 715 in some other examples (e.g., one or more subbands that are narrower than 715a and/or one or more subbands that are wider than the subband 715a and narrower than the subband 715b).

In some examples, the BWP configuration 705 may be associated with a TCI configuration 720 and a CSI configuration 725 (e.g., a CSI measurement configuration and/or a CSI reporting configuration). For example, the BWP configuration 705 may indicate the TCI configuration 720 and/or the CSI configuration 725 (e.g., via a same signaling as the BWP configuration 705, or via different signaling) or may activate the TCI configuration 720 and/or the CSI configuration 725 (e.g., based on previous signaling). As described herein, the TCI configuration 720 may indicate one or more TCI states that are valid and/or invalid for at least one of the subband 715a or the subband 715b, and the CSI configuration 725 may indicate one or more CSI-RS resources 735 that are valid and/or invalid for at least one of the subband 715a or the subband 715b.

In some aspects, the TCI configuration 720 may indicate a plurality of TCI states common for the subband 715a and the subband 715b (e.g., via a tci-StatesToAddModList parameter). For example, the TCI configuration 720 may correspond to a set of one or more beams 730, which may each correspond to a respective TCI states of the plurality of TCI states. In some examples, the UE 120 may be configured with an indication (e.g., a rule) to differentiate which of the plurality of TCI states (for example, or respective beams) are valid or invalid for the subband 715a or the subband 715b. For example, the network node 110 may configure the UE 120 (e.g., via RRC signaling, via the TCI configuration 720, or via the BWP configuration 705) with a mask that validates and/or invalidates one or more TCI states of the plurality of TCI states for at least one of the subband 715a or the subband 715b. In some aspects, the network node 110 may signal one or more bits indicating a bitmap, and the bitmap may be used to validate or invalidate the one or more TCI states. For example, the bitmap may include a bit corresponding to each TCI state of the plurality of TCI states. A bit having a first value (e.g., zero) may indicate that a corresponding TCI state is not valid for a subband 715, and a bit having a second value (e.g., one) may indicate that a corresponding TCI state is valid for the subband 715. In some aspects, the indication may indicate which TCI states are valid or invalid for the active subband 715. Additionally, or alternatively, the indication may indicate which TCI states are valid or invalid for a narrow subband 715 (e.g., the subband 715a). For example, the plurality of TCI states (e.g., indicated via the TCI configuration 720) may be valid for the subband 715b, and the indication (e.g., the mask) may indicate which TCI states of the plurality of TCI states are valid and/or invalid for the subband 715a. Accordingly, when indicating a TCI state to activate for the active subband 715, the network node 110 may refrain from indicating a TCI state that is invalid for the active subband 715 in accordance with the validity indication.

In some aspects, the subband 715a and the subband 715b may be associated with a common (e.g., same) CORESET configuration and a common (e.g., same) DCI size. For instance, as the DCI size may be the same between both subbands 715, a DCI field size associated with indicating a TCI state may be set in accordance with a subband 715 having a largest number of valid TCI states, which may be a broadest subband 715 (e.g., the subband 715b). For example, when the UE 120 is operating using the subband 715a (e.g., which may be associated with a smaller number of valid TCI states than the subband 715b), the network node 110 may zero pad the DCI field indicating a TCI state. In some cases, the DCI field when the UE 120 operating using the subband 715a may be zero padded such that the DCI field size common to the subband 715a and the subband 715b supports indicating a TCI state when the UE 120 operating using the subband 715b. Accordingly, the network node 110 may refrain from indicating any TCI states via the DCI that are invalid for the subband 715a, and the DCI may indicate communication parameters for the subband 715a in accordance with the narrower bandwidth of the subband 715a (e.g., narrower beams). Additionally, or alternatively, the network node 110 may configure a separate table for each of the subband 715a and the subband 715b (e.g., via RRC signaling, the CSI configuration 725, or the BWP configuration 705). For example, to indicate a TCI state for an active subband 715, the network node 110 may indicate a codepoint (e.g., via the DCI) that indicates one or more TCI states to activate based on the table that corresponds to the active subband 715.

Accordingly, the DCI field size may remain constant regardless of whether the UE 120 is operating using the subband 715a or the subband 715b, thereby avoiding reconfiguration of the UE 120 and allowing the UE 120 to decode the received DCI when operating using either of the subband 715a or the subband 715b. For example, because the CORSET configuration and the DCI size are common to all subbands 715, the network node 110 may transmit DCI on a resource such that the UE 120 may receive the DCI when operating using either of the subband 715a or the subband 715b. Therefore, the UE 120 may decode DCI even in cases when the UE 120 does not successfully receive or decode previous signaling indicating a subband switch, such as when experiencing out-of-service conditions.

Additionally, or alternatively, the network node 110 may activate or deactivate a TCI state for the active subband 715 via a MAC-CE message. For example, any TCI state of the plurality of TCI states may be valid for the subband 715b, and the MAC-CE message may indicate one or more of the TCI states that are valid for the subband 715b to activate or deactivate the indicated one or more TCI states when the UE 120 is operating using the subband 715b. When the UE 120 is operating using the subband 715a, the network node 110 may refrain from indicating (e.g., and the UE 120 is not to expect an indication of) a TCI state that is invalid for the subband 715a via the MAC-CE message that activates or deactivates one or more TCI states for the subband 715a.

Additionally, or alternatively, to indicate TCI states for the subband 715a and the subband 715b, the TCI configuration 720 may indicate a respective common resource pool for all subbands 715 of the BWP 710. In some examples, the TCI configuration 720 may indicate a common resource pool (e.g., a table) including a number of TCI states corresponding to #subbands×#ofTCIStates, where #subbands corresponds to a number of subbands configured for the BWP 710 and #ofTCIStates corresponds to a number of TCI states configured for each subband. For example, for configuring 128 TCI states for each of four subbands 715, the TCI configuration 720 may indicate a common resource pool including 6×128 TCI states (e.g., a 6×128 table). The network node 110 may indicate TCI states that are valid for a subband 715 by indicating an index, thereby reducing the number of bits associated with a bitmap for validating or invalidating TCI states. For example, in the case of the 6×128 TCI states, the network node 110 may indicate an index with a value between zero and #subbands −1, and the network node 110 may indicate a bitmap of size 1×128 bits to indicate which TCI states are valid for the active subband 715, thereby compressing the bitmap relative to indicating a 6×128-size bitmap. Accordingly, the network node 110 may reduce transmission overhead associated with indicating valid TCI states for a subband 715 (e.g., a bitmap of size #subbands ×#ofTCIStates is compressed to a size of 1×#ofTCIStates). In some cases, the number of indices (e.g., the maximum supported indices) may be based on a capability of the UE 120.

Similarly, to indicate CSI-RS resources 735 for the subband 715a and the subband 715b, the CSI configuration 725 may indicate a common resource pool (e.g., a table) for all subbands 715 of the BWP 705. The common resource pool may include a number of CSI-RS resources corresponding to #subbands×#ofCSI-RSResources, where #CSI-RSResources may correspond to the number of CSI-RS resources 735 configured for each subband 715. For example, for configuring 66 CSI-RS resources for four subbands 715, the CSI configuration 725 may indicate 6×66 CSI-RS resources (e.g., a 6×66 table). The network node 110 may indicate CSI-RS resources that are valid for a subband 715 by indicating an index, thereby reducing the number of bits associated with a bitmap for validating or invalidating CSI-RS resources. For example, in the case of the 6×66 CSI-RS resources, the network node 110 may indicate an index with a value between zero and three, and the network node 110 may indicate a bitmap of size 1×66 bits to indicate which CSI-RS resources 735 are valid for the active subband 715, thereby compressing the bitmap relative to indicating a 6×66-size bitmap (e.g., a bitmap of size #subbands×#ofCSI-RSResources may be compressed to a size of 1×#ofCSI-RSResources). The number of indices (e.g., the maximum supported indices) associated with CSI-RS resource indication may be based on a capability of the UE 120.

Additionally, or alternatively, to configure CSI-RS resources 735 for the subband 715a and the subband 715b, the CSI configuration 725 may indicate a plurality of CSI-RS resources 735 for the broadest subband 715, which may be the subband 715b, and each of the plurality of CSI-RS resources 735 may be valid for the subband 715b. When operating using the subband 715a, the UE 120 may be configured to exclude (e.g., ignore) CSI-RS resources of the plurality of CSI-RS resources 735 that are outside the subband 715a. In some examples, the CSI-RS configuration 725 may indicate whether CSI reporting is configured for the subband 715a and/or the subband 715b. Accordingly, the UE 120 may monitor CSI-RS resources 735 in accordance with the active subband 715, without receiving additional signaling associated with indicating additional CSI-RS resources 735 during a subband switching procedure.

Additionally, or alternatively, the CSI configuration 725 may indicate separate configurations to indicate CSI-RS resources 735 for each subband 715. For example, the CSI configuration 725 may be or may include a first CSI configuration for the subband 715a and a second CSI configuration for the subband 715b. In some aspects, the first CSI configuration may indicate one or more CSI-RS resources 735 (e.g., periodic resources, aperiodic resources, semi-persistent resources) for the subband 715a, and the second configuration may indicate one or more CSI-RS resources 735 (e.g., periodic resources, aperiodic resources, semi-persistent resources) for the subband 715b. In some examples, the CSI-RS configuration 725 may indicate whether the UE 120 is to include measurement reports for the subband 715a and the subband 715b in a same CSI report. Additionally, or alternatively, the CSI-RS configuration 725 may indicate whether the UE 120 is to perform (e.g., separate) CSI reporting for each of subband 715a and the subband 715b, or whether the UE 120 is to perform CSI reporting only for one of the subbands 715.

In some aspects, a number of trigger states associated with CSI reporting configured for the UE 120 may be independent of the BWP configuration 705. For example, the network node 110 may configure a total number of trigger states (e.g., 66 trigger states) that are shared among all of the subbands 715 (e.g., the subband 715a and the subband 715b) of the BWP 710. Additionally, or alternatively, a total number of report states (e.g., report state triggers) may be independent of the BWP configuration 705. For example, the network node 110 may configure a total number of report states (e.g., 16 report states) that are shared among all of the subbands 715 of the BWP 710. In some examples, the total product of the trigger states and the report states may be independent of the BWP configuration 705. For example, the product of the trigger states and the report states (e.g., 66×16) may be shared among all of the subbands 715 of the BWP 710. In some cases, the number of trigger states, the number of report states, the product thereof, or any combination thereof, may be based on a capability of the UE 120 associated with CSI reporting.

Accordingly, the TCI configuration 720 and the CSI configuration 725 may support configuring TCI states and CSI-RS resources 735 for the subband 715a and the subband 715b. Consequently, the signaling of additional configurations when the network node 110 signals a new active subband 715 for the UE 120 may be avoided, thereby reducing communication overhead and latency associated with subband switching.

As indicated above, FIG. 7 is provided as an example. Other examples may differ from what is described with regard to FIG. 7.

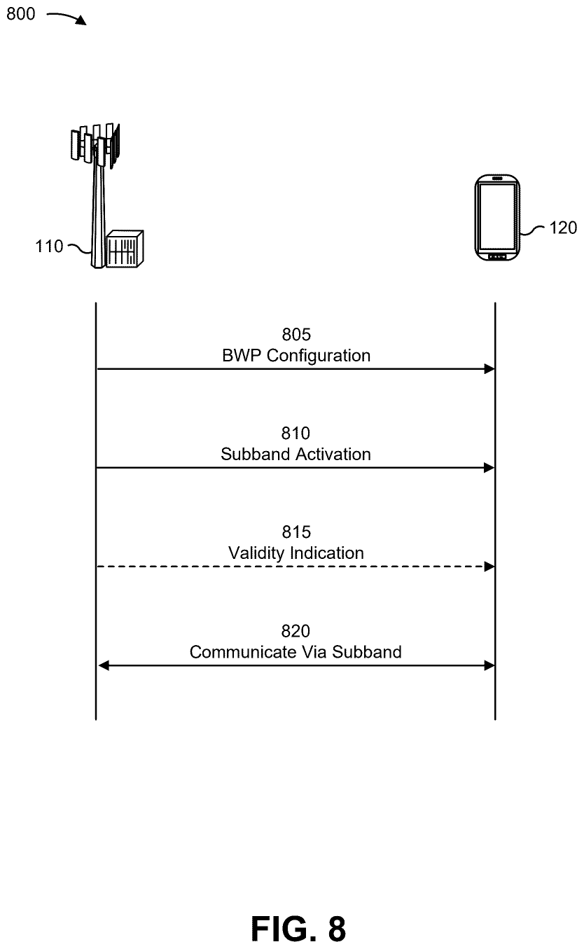

FIG. 8 is a diagram of an example 800 associated with adapting communication parameters for a BWP, in accordance with the present disclosure. As shown in FIG. 8, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 8.

As shown by reference number 805, the network node 110 may transmit, and the UE 120 may receive, a BWP configuration. In some aspects, the BWP configuration may configure a BWP that includes at least a first subband having a first set of RBs and a second subband having a second set of RBs. In some examples, the BWP configuration may be associated with a set of TCI states and/or a set of CSI-RS resources that are valid for at least one of the first subband or the second subband. In some cases, the BWP configuration may indicate a first subset of the set of TCI states associated with the first subband and a second subset of the set of TCI states associated with the second subband, as described herein. Additionally, or alternatively, the BWP configuration may indicate a first subset of the set of CSI-RS resources associated with the first subband and a second subset of the set of CSI-RS resources associated with the second subband, as described herein.

As shown by reference number 805, the network node 110 may transmit, and the UE 120 may receive, a message activating the first subband for communications. For example, the UE 120 may operate using the first subband as an operating bandwidth for communications with the network node 110. In some examples, the UE 120 may apply the at least one TCI state based on a satisfaction of criteria (e.g., validity criteria) indicating that the at least one TCI state is valid for the first subband. Additionally, or alternatively, the UE 120 may perform CSI measurements using at least one CSI-RS resource based on a satisfaction of criteria (e.g., validity criteria) indicating that the at least one CSI-RS resource is valid for the first subband.

As shown by reference number 815, the network node 110 may transmit, and the UE 120 may receive, an indication (e.g., a validity indication) that indicates which TCI states of the set of TCI states are valid for the first subband, which CSI-RS resources of the set of CSI-RS resources are valid for the first subband, or a combination thereof, as described herein with reference to FIG. 6. In some examples, the indication may include a bitmap, one or more bits of the bitmap each having a first value or a second value, where a bit having the first value indicates a TCI state being valid for the first subband and a bit having the second value indicates a TCI state being invalid for the first subband. In some aspects, the indication may include receiving a message indicating an index, where the index indicates the first subset of the set of TCI states associated with the first subband, and receiving a message indicating a bitmap, where one or more bits of the bitmap having a first value indicate one or more TCI states of the first subset of the set of TCI states that are active for communication via the first subband. Additionally, or alternatively, the validity indication may include receiving a message indicating an index, where the index indicates the first subset of the set of CSI-RS resources associated with the first subband, and receiving a message indicating a bitmap, where one or more bits of the bitmap having a first value indicate one or more CSI-RS resources of the first subset of the set of CSI-RS resources that are active for communication via the first subband.

In some examples, the validity indication may be included with the BWP configuration (e.g., as shown by reference number 805), included with the subband activation message (e.g., as shown by reference number 810), or may be signaled via one or more separate messages (e.g., DCI, a MAC-CE message(s), RRC message(s)).

As shown by reference number 820, the network node 110 and the UE 120 may communicate via the first subband in accordance with the activation of the first subband. For example, the UE 120 may communicate in accordance with one or more TCI states valid for the first subband. Additionally, or alternatively, the UE 120 may perform CSI measurements in accordance with one or more CSI-RS resources valid for the first subband, and the UE 120 may perform CSI reporting in accordance with the CSI measurements.

Accordingly, the BWP configuration may support configuring TCI states and CSI-RS resources for the first subband and the second subband, avoiding the signaling of additional configurations when the network node 110 signals a new active subband for the UE 120. Consequently, communication overhead and latency associated with subband switching may be reduced relative to performing a BWP switch, which may support reducing power consumption and latency at the UE.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with adapting communication parameters for a BWP.

As shown in FIG. 9, in some aspects, process 900 may include receiving, from a network node, a BWP configuration that configures a BWP, the BWP including at least a first subband having a first set of RBs and a second subband having a second set of RBs, wherein the BWP configuration is associated with a set of transmission TCI states, a set of CSI-RS resources, or both, valid for at least one of the first subband or the second subband (block 910). For example, the UE (e.g., using reception component 1102 and/or communication manager 1106, depicted in FIG. 11) may receive, from a network node, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband, as described above.

As further shown in FIG. 9, in some aspects, process 900 may include receiving, from the network node, a message activating the first subband for communications (block 920). For example, the UE (e.g., using reception component 1102 and/or communication manager 1106, depicted in FIG. 11) may receive, from the network node, a message activating the first subband for communications, as described above.

As further shown in FIG. 9, in some aspects, process 900 may include communicating with the network node in accordance with at least one TCI state of the set of TCI states or at least one CSI-RS resource of the set of CSI-RS resources that are valid for the first subband and the message activating the first subband (block 930). For example, the UE (e.g., using reception component 1102, transmission component 1104, and/or communication manager 1106, depicted in FIG. 11) may communicate with the network node in accordance with at least one TCI state of the set of TCI states or at least one CSI-RS resource of the set of CSI-RS resources that are valid for the first subband and the message activating the first subband, as described above.

Process 900 may include additional aspects, such as any single aspect or any combination of aspects described below and/or in connection with one or more other processes described elsewhere herein.

In a first aspect, process 900 includes receiving, from the network node, a message indicating a first subset of the set of TCI states that is valid for the first subband and a second subset of the set of TCI states that is invalid for the first subband, wherein the first subset comprises the at least one TCI state valid for the first subband.

In a second aspect, alone or in combination with the first aspect, the message includes a bitmap, one or more bits of the bitmap each having a first value or a second value, wherein a bit having the first value indicates a TCI state being valid for the first subband and a bit having the second value indicates a TCI state being invalid for the first subband.

In a third aspect, alone or in combination with one or more of the first and second aspects, process 900 includes applying the at least one TCI state based at least in part on a satisfaction of validity criteria indicating that the at least one TCI state is valid for the first subband.

In a fourth aspect, alone or in combination with one or more of the first through third aspects, process 900 includes receiving a first DCI message including a first TCI field indicating the at least one TCI state, wherein a size of the first TCI field is based at least in part on a number of TCI states of the set of TCI states that are valid for at least one of the first subband or the second subband.

In a fifth aspect, alone or in combination with one or more of the first through fourth aspects, the first TCI field indicates at least one TCI state in accordance a size of the first subband.

In a sixth aspect, alone or in combination with one or more of the first through fifth aspects, the first TCI field includes zero padding based at least in part on a size of the first subband.

In a seventh aspect, alone or in combination with one or more of the first through sixth aspects, process 900 includes receiving a message activating the second subband for communications, receiving a second DCI message including a second TCI field indicating a second TCI state, wherein the second TCI field has a size equal to the size of the first TCI field, and communicating with the network node in accordance with the second TCI state based at least in part on the second TCI field and the message activating the second subband.

In an eighth aspect, alone or in combination with one or more of the first through seventh aspects, the first TCI field indicates the at least one TCI state based at least in part on a first mapping table associated with the first subband, and the second TCI field indicates the second TCI state based at least in part on a second mapping table associated with the second subband.

In a ninth aspect, alone or in combination with one or more of the first through eighth aspects, the BWP configuration indicates a first subset of the set of TCI states associated with the first subband and a second subset of the set of TCI states associated with the second subband.

In a tenth aspect, alone or in combination with one or more of the first through ninth aspects, process 900 includes receiving a message indicating an index, wherein the index indicates the first subset of the set of TCI states associated with the first subband, and receiving a message indicating a bitmap, wherein one or more bits of the bitmap having a first value indicate one or more TCI states of the first subset of the set of TCI states that are active for communication via the first subband.

In an eleventh aspect, alone or in combination with one or more of the first through tenth aspects, the BWP configuration indicates a first subset of the set of CSI-RS resources associated with the first subband and a second subset of the set of CSI-RS resources associated with the second subband.

In a twelfth aspect, alone or in combination with one or more of the first through eleventh aspects, process 900 includes receiving a message indicating an index, wherein the index indicates the first subset of the set of CSI-RS resources associated with the first subband, and receiving a message indicating a bitmap, wherein one or more bits of the bitmap having a first value indicate one or more CSI-RS resources of the first subset of the set of CSI-RS resources that are active for communication via the first subband.

In a thirteenth aspect, alone or in combination with one or more of the first through twelfth aspects, the BWP configuration indicates a set of CSI-RS resources valid for the second subband.

In a fourteenth aspect, alone or in combination with one or more of the first through thirteenth aspects, process 900 includes communicating with the network node in accordance with a subset of the set of CSI-RS resources valid for the second subband, the subset of the set of CSI-RS resources selected based at least in part on a size of the first subband.

In a fifteenth aspect, alone or in combination with one or more of the first through fourteenth aspects, the BWP configuration indicates a first set of periodic CSI-RS resources valid for the first subband and a second set of periodic CSI-RS resources valid for the second subband.

In a sixteenth aspect, alone or in combination with one or more of the first through fifteenth aspects, the second subband extends a full bandwidth of the BWP, and the first subband extends a portion of the full bandwidth.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with adapting communication parameters for a BWP.

As shown in FIG. 10, in some aspects, process 1000 may include transmitting, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband (block 1010). For example, the network node (e.g., using transmission component 1204 and/or communication manager 1206, depicted in FIG. 12) may transmit, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband, as described above.

As further shown in FIG. 10, in some aspects, process 1000 may include transmitting, to the UE, a message activating the first subband for communications (block 1020). For example, the network node (e.g., using transmission component 1204 and/or communication manager 1206, depicted in FIG. 12) may transmit, to the UE, a message activating the first subband for communications, as described above.

As further shown in FIG. 10, in some aspects, process 1000 may include communicating with the UE in accordance with at least one TCI state of the set of TCI states valid for the first subband or at least one CSI-RS resource of the set of CSI-RS resources valid for the first subband and the message activating the first subband (block 1030). For example, the network node (e.g., using reception component 1202, transmission component 1204, and/or communication manager 1206, depicted in FIG. 12) may communicate with the UE in accordance with at least one TCI state of the set of TCI states valid for the first subband or at least one CSI-RS resource of the set of CSI-RS resources valid for the first subband and the message activating the first subband, as described above.

Process 1000 may include additional aspects, such as any single aspect or any combination of aspects described below and/or in connection with one or more other processes described elsewhere herein.

In a first aspect, process 1000 includes transmitting, to the UE, a message indicating a first subset of the set of TCI states that is valid for the first subband and a second subset of the set of TCI states that is invalid for the first subband, wherein the first subset comprises the at least one TCI state valid for the first subband.

In a second aspect, alone or in combination with the first aspect, the message includes a bitmap, one or more bits of the bitmap each having a first value or a second value, wherein a bit having the first value indicates a TCI state being valid for the first subband and a bit having the second value indicates a TCI state being invalid for the first subband.

In a third aspect, alone or in combination with one or more of the first and second aspects, process 1000 includes transmitting a first DCI message including a first TCI field indicating the at least one TCI state, wherein a size of the first TCI field is based at least in part on a number of TCI states of the set of TCI states that are valid for at least one of the first subband or the second subband.

In a fourth aspect, alone or in combination with one or more of the first through third aspects, the first TCI field indicates at least one TCI state in accordance with a size of the first subband.

In a fifth aspect, alone or in combination with one or more of the first through fourth aspects, the first TCI field includes zero padding based at least in part on a size of the first subband.

In a sixth aspect, alone or in combination with one or more of the first through fifth aspects, process 1000 includes transmitting a message indicating the second subband for communications, transmitting a second DCI message including a second TCI field indicating a second TCI state, wherein the second TCI field has a size equal to the size of the first TCI field, and communicating with the UE in accordance with the second TCI state based at least in part on the second TCI field.

In a seventh aspect, alone or in combination with one or more of the first through sixth aspects, the first TCI field indicates the at least one TCI state based at least in part on a first mapping table associated with the first subband, and the second TCI field indicates the second TCI state based at least in part on a second mapping table associated with the second subband.

In an eighth aspect, alone or in combination with one or more of the first through seventh aspects, the BWP configuration indicates a first subset of the set of TCI states associated with the first subband and a second subset of the set of TCI states associated with the second subband.

In a ninth aspect, alone or in combination with one or more of the first through eighth aspects, process 1000 includes transmitting a message indicating an index, wherein the index indicates the first subset of the set of TCI states associated with the first subband, and transmitting a message indicating a bitmap, wherein one or more bits of the bitmap having a first value indicate one or more TCI states of the first subset of the set of TCI states that are active for communication via the first subband.

In a tenth aspect, alone or in combination with one or more of the first through ninth aspects, the BWP configuration indicates a first subset of the set of CSI-RS resources associated with the first subband and a second subset of the set of CSI-RS resources associated with the second subband.

In an eleventh aspect, alone or in combination with one or more of the first through tenth aspects, process 1000 includes transmitting a message indicating an index, wherein the index indicates the first subset of the set of CSI-RS resources associated with the first subband, and transmitting a message indicating a bitmap, wherein one or more bits of the bitmap having a first value indicate one or more CSI-RS resources of the first subset of the set of CSI-RS resources that are active for communication via the first subband.

In a twelfth aspect, alone or in combination with one or more of the first through eleventh aspects, the BWP configuration indicates a set of CSI-RS resources valid for the second subband.

In a thirteenth aspect, alone or in combination with one or more of the first through twelfth aspects, process 1000 includes communicating with the UE in accordance with a subset of the set of CSI-RS resources valid for the second subband, the subset of the set of CSI-RS resources selected based at least in part on a size of the first subband.

In a fourteenth aspect, alone or in combination with one or more of the first through thirteenth aspects, the BWP configuration indicates a first set of periodic CSI-RS resources valid for the first subband and a second set of periodic CSI-RS resources valid for the second subband.

In a fifteenth aspect, alone or in combination with one or more of the first through fourteenth aspects, the second subband extends a full bandwidth of the BWP, and the first subband extends a portion of the full bandwidth.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 7 and 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The reception component 1102 may receive, from the network node, a message activating the first subband for communications. The reception component 1102 and/or the transmission component 1104 may communicate with the network node in accordance with at least one TCI state of the set of TCI states or at least one CSI-RS resource of the set of CSI-RS resources that are valid for the first subband and the message activating the first subband.

The reception component 1102 may receive, from the network node, a message indicating a first subset of the set of TCI states that is valid for the first subband and a second subset of the set of TCI states that is invalid for the first subband, wherein the first subset comprises the at least one TCI state valid for the first subband.

The communication manager 1106 may apply the at least one TCI state based at least in part on a satisfaction of validity criteria indicating that the at least one TCI state is valid for the first subband.

The reception component 1102 may receive a first DCI message including a first TCI field indicating the at least one TCI state, wherein a size of the first TCI field is based at least in part on a number of TCI states of the set of TCI states that are valid for at least one of the first subband or the second subband.

The reception component 1102 may receive a message activating the second subband for communications.

The reception component 1102 may receive a second DCI message including a second TCI field indicating a second TCI state, wherein the second TCI field has a size equal to the size of the first TCI field.

The communication manager 1106 may communicate with the network node in accordance with the second TCI state based at least in part on the second TCI field and the message activating the second subband.

The reception component 1102 may receive a message indicating an index, wherein the index indicates the first subset of the set of TCI states associated with the first subband.

The reception component 1102 may receive a message indicating a bitmap, wherein one or more bits of the bitmap having a first value indicate one or more TCI states of the first subset of the set of TCI states that are active for communication via the first subband.

The reception component 1102 may receive a message indicating an index, wherein the index indicates the first subset of the set of CSI-RS resources associated with the first subband.

The reception component 1102 may receive a message indicating a bitmap, wherein one or more bits of the bitmap having a first value indicate one or more CSI-RS resources of the first subset of the set of CSI-RS resources that are active for communication via the first subband.

The communication manager 1106 may communicate with the network node in accordance with a subset of the set of CSI-RS resources valid for the second subband, the subset of the set of CSI-RS resources selected based at least in part on a size of the first subband.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 7 and 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband. The transmission component 1204 may transmit, to the UE, a message activating the first subband for communications. The reception component 1202 and/or the transmission component 1204 may communicate with the UE in accordance with at least one TCI state of the set of TCI states valid for the first subband or at least one CSI-RS resource of the set of CSI-RS resources valid for the first subband and the message activating the first subband.

The transmission component 1204 may transmit, to the UE, a message indicating a first subset of the set of TCI states that is valid for the first subband and a second subset of the set of TCI states that is invalid for the first subband, wherein the first subset comprises the at least one TCI state valid for the first subband.

The transmission component 1204 may transmit a first DCI message including a first TCI field indicating the at least one TCI state, wherein a size of the first TCI field is based at least in part on a number of TCI states of the set of TCI states that are valid for at least one of the first subband or the second subband.

The transmission component 1204 may transmit a message indicating the second subband for communications. The transmission component 1204 may transmit a second DCI message including a second TCI field indicating a second TCI state, wherein the second TCI field has a size equal to the size of the first TCI field. The communication manager 1206 may communicate with the UE in accordance with the second TCI state based at least in part on the second TCI field.

The transmission component 1204 may transmit a message indicating an index, wherein the index indicates the first subset of the set of TCI states associated with the first subband. The transmission component 1204 may transmit a message indicating a bitmap, wherein one or more bits of the bitmap having a first value indicate one or more TCI states of the first subset of the set of TCI states that are active for communication via the first subband.

The transmission component 1204 may transmit a message indicating an index, wherein the index indicates the first subset of the set of CSI-RS resources associated with the first subband. The transmission component 1204 may transmit a message indicating a bitmap, wherein one or more bits of the bitmap having a first value indicate one or more CSI-RS resources of the first subset of the set of CSI-RS resources that are active for communication via the first subband.

The communication manager 1206 may communicate with the UE in accordance with a subset of the set of CSI-RS resources valid for the second subband, the subset of the set of CSI-RS resources selected based at least in part on a size of the first subband.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving, from a network node, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband; receiving, from the network node, a message activating the first subband for communications; and communicating with the network node in accordance with at least one TCI state of the set of TCI states or at least one CSI-RS resource of the set of CSI-RS resources that are valid for the first subband and the message activating the first subband.

Aspect 2: The method of Aspect 1, further comprising: receiving, from the network node, a message indicating a first subset of the set of TCI states that is valid for the first subband and a second subset of the set of TCI states that is invalid for the first subband, wherein the first subset comprises the at least one TCI state valid for the first subband.

Aspect 3: The method of Aspect 2, wherein the message includes a bitmap, one or more bits of the bitmap each having a first value or a second value, wherein a bit having the first value indicates a TCI state being valid for the first subband and a bit having the second value indicates a TCI state being invalid for the first subband.

Aspect 4: The method of any of Aspects 1-3, further comprising: applying the at least one TCI state based at least in part on a satisfaction of validity criteria indicating that the at least one TCI state is valid for the first subband.

Aspect 5: The method of any of Aspects 1-4, further comprising: receiving a first DCI message including a first TCI field indicating the at least one TCI state, wherein a size of the first TCI field is based at least in part on a number of TCI states of the set of TCI states that are valid for at least one of the first subband or the second subband.

Aspect 6: The method of Aspect 5, wherein the first TCI field indicates at least one TCI state in accordance a size of the first subband.

Aspect 7: The method of Aspect 5, wherein the first TCI field includes zero padding based at least in part on a size of the first subband.

Aspect 8: The method of Aspect 5, further comprising: receiving a message activating the second subband for communications; receiving a second DCI message including a second TCI field indicating a second TCI state, wherein the second TCI field has a size equal to the size of the first TCI field; and communicating with the network node in accordance with the second TCI state based at least in part on the second TCI field and the message activating the second subband.

Aspect 9: The method of Aspect 8, wherein the first TCI field indicates the at least one TCI state based at least in part on a first mapping table associated with the first subband, and the second TCI field indicates the second TCI state based at least in part on a second mapping table associated with the second subband.

Aspect 10: The method of any of Aspects 1-9, wherein the BWP configuration indicates a first subset of the set of TCI states associated with the first subband and a second subset of the set of TCI states associated with the second subband.

Aspect 11: The method of Aspect 10, further comprising: receiving a message indicating an index, wherein the index indicates the first subset of the set of TCI states associated with the first subband; and receiving a message indicating a bitmap, wherein one or more bits of the bitmap having a first value indicate one or more TCI states of the first subset of the set of TCI states that are active for communication via the first subband.

Aspect 12: The method of any of Aspects 1-11, wherein the BWP configuration indicates a first subset of the set of CSI-RS resources associated with the first subband and a second subset of the set of CSI-RS resources associated with the second subband.

Aspect 13: The method of Aspect 12, further comprising: receiving a message indicating an index, wherein the index indicates the first subset of the set of CSI-RS resources associated with the first subband; and receiving a message indicating a bitmap, wherein one or more bits of the bitmap having a first value indicate one or more CSI-RS resources of the first subset of the set of CSI-RS resources that are active for communication via the first subband.

Aspect 14: The method of any of Aspects 1-13, wherein the BWP configuration indicates a set of CSI-RS resources valid for the second subband.

Aspect 15: The method of Aspect 14, further comprising: communicating with the network node in accordance with a subset of the set of CSI-RS resources valid for the second subband, the subset of the set of CSI-RS resources selected based at least in part on a size of the first subband.

Aspect 16: The method of any of Aspects 1-15, wherein the BWP configuration indicates a first set of periodic CSI-RS resources valid for the first subband and a second set of periodic CSI-RS resources valid for the second subband.

Aspect 17: The method of any of Aspects 1-16, wherein the second subband extends a full bandwidth of the BWP, and the first subband extends a portion of the full bandwidth.

Aspect 18: A method of wireless communication performed by a network node, comprising: transmitting, to a UE, a BWP configuration that configures a BWP, the BWP including at least a first subband having a first set of RBs and a second subband having a second set of RBs, wherein the BWP configuration is associated with a set of TCI states, a set of CSI-RS resources, or both, valid for at least one of the first subband or the second subband; transmitting, to the UE, a message activating the first subband for communications; and communicating with the UE in accordance with at least one TCI state of the set of TCI states valid for the first subband or at least one CSI-RS resource of the set of CSI-RS resources valid for the first subband and the message activating the first subband.

Aspect 19: The method of Aspect 18, further comprising: transmitting, to the UE, a message indicating a first subset of the set of TCI states that is valid for the first subband and a second subset of the set of TCI states that is invalid for the first subband, wherein the first subset comprises the at least one TCI state valid for the first subband.

Aspect 20: The method of Aspect 19, wherein the message includes a bitmap, one or more bits of the bitmap each having a first value or a second value, wherein a bit having the first value indicates a TCI state being valid for the first subband and a bit having the second value indicates a TCI state being invalid for the first subband.

Aspect 21: The method of any of Aspects 18-20, further comprising: transmitting a first DCI message including a first TCI field indicating the at least one TCI state, wherein a size of the first TCI field is based at least in part on a number of TCI states of the set of TCI states that are valid for at least one of the first subband or the second subband.

Aspect 22: The method of Aspect 21, wherein the first TCI field indicates at least one TCI state in accordance with a size of the first subband.

Aspect 23: The method of Aspect 21, wherein the first TCI field includes zero padding based at least in part on a size of the first subband.

Aspect 24: The method of Aspect 21, further comprising: transmitting a message indicating the second subband for communications; transmitting a second DCI message including a second TCI field indicating a second TCI state, wherein the second TCI field has a size equal to the size of the first TCI field; and communicating with the UE in accordance with the second TCI state based at least in part on the second TCI field.

Aspect 25: The method of Aspect 24, wherein the first TCI field indicates the at least one TCI state based at least in part on a first mapping table associated with the first subband, and the second TCI field indicates the second TCI state based at least in part on a second mapping table associated with the second subband.

Aspect 26: The method of any of Aspects 18-25, wherein the BWP configuration indicates a first subset of the set of TCI states associated with the first subband and a second subset of the set of TCI states associated with the second subband.

Aspect 27: The method of Aspect 26, further comprising: transmitting a message indicating an index, wherein the index indicates the first subset of the set of TCI states associated with the first subband; and transmitting a message indicating a bitmap, wherein one or more bits of the bitmap having a first value indicate one or more TCI states of the first subset of the set of TCI states that are active for communication via the first subband.

Aspect 28: The method of any of Aspects 18-27, wherein the BWP configuration indicates a first subset of the set of CSI-RS resources associated with the first subband and a second subset of the set of CSI-RS resources associated with the second subband.

Aspect 29: The method of Aspect 27, further comprising: transmitting a message indicating an index, wherein the index indicates the first subset of the set of CSI-RS resources associated with the first subband; and transmitting a message indicating a bitmap, wherein one or more bits of the bitmap having a first value indicate one or more CSI-RS resources of the first subset of the set of CSI-RS resources that are active for communication via the first subband.

Aspect 30: The method of any of Aspects 18-29, wherein the BWP configuration indicates a set of CSI-RS resources valid for the second subband.

Aspect 31: The method of Aspect 30, further comprising: communicating with the UE in accordance with a subset of the set of CSI-RS resources valid for the second subband, the subset of the set of CSI-RS resources selected based at least in part on a size of the first subband.

Aspect 32: The method of any of Aspects 18-31, wherein the BWP configuration indicates a first set of periodic CSI-RS resources valid for the first subband and a second set of periodic CSI-RS resources valid for the second subband.

Aspect 33: The method of any of Aspects 18-32, wherein the second subband extends a full bandwidth of the BWP, and the first subband extends a portion of the full bandwidth.

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.

Aspect 35: An apparatus for wireless communication at a device, the apparatus comprising one or more memories and one or more processors coupled to the one or more memories, the one or more processors configured to cause the device to perform the method of one or more of Aspects 1-33.

Aspect 36: An apparatus for wireless communication, the apparatus comprising at least one means for performing the method of one or more of Aspects 1-33.

Aspect 37: A non-transitory computer-readable medium storing code for wireless communication, the code comprising instructions executable by one or more processors to perform the method of one or more of Aspects 1-33.

Aspect 38: A non-transitory computer-readable medium storing a set of instructions for wireless communication, the set of instructions comprising one or more instructions that, when executed by one or more processors of a device, cause the device to perform the method of one or more of Aspects 1-33.

Aspect 39: A device for wireless communication, the device comprising a processing system that includes one or more processors and one or more memories coupled with the one or more processors, the processing system configured to cause the device to perform the method of one or more of Aspects 1-33.

Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
receiving, from a network node, a bandwidth part (BWP) configuration that configures a BWP, the BWP including at least a first subband having a first set of resource blocks (RBs) and a second subband having a second set of RBs, wherein the BWP configuration is associated with a set of transmission configuration indication (TCI) states, a set of channel state information reference signal (CSI-RS) resources, or both, valid for at least one of the first subband or the second subband;
receiving, from the network node, a message activating the first subband for communications; and
communicating with the network node in accordance with at least one TCI state of the set of TCI states or at least one CSI-RS resource of the set of CSI-RS resources that are valid for the first subband and the message activating the first subband.

2. The method of claim 1, further comprising:
receiving, from the network node, a message indicating a first subset of the set of TCI states that is valid for the first subband and a second subset of the set of TCI states that is invalid for the first subband, wherein the first subset comprises the at least one TCI state valid for the first subband.

3. The method of claim 2, wherein the message includes a bitmap, one or more bits of the bitmap each having a first value or a second value, wherein a bit having the first value indicates a TCI state being valid for the first subband and a bit having the second value indicates a TCI state being invalid for the first subband.

4. The method of claim 1, further comprising:
applying the at least one TCI state based at least in part on a satisfaction of validity criteria indicating that the at least one TCI state is valid for the first subband.

5. The method of claim 1, further comprising:
receiving a first downlink control information (DCI) message including a first TCI field indicating the at least one TCI state, wherein a size of the first TCI field is based at least in part on a number of TCI states of the set of TCI states that are valid for at least one of the first subband or the second subband.

6. The method of claim 5, wherein the first TCI field indicates at least one TCI state in accordance a size of the first subband.

7. The method of claim 5, wherein the first TCI field includes zero padding based at least in part on a size of the first subband.

8. The method of claim 5, further comprising:
receiving a message activating the second subband for communications;
receiving a second DCI message including a second TCI field indicating a second TCI state, wherein the second TCI field has a size equal to the size of the first TCI field; and
communicating with the network node in accordance with the second TCI state based at least in part on the second TCI field and the message activating the second subband.

9. The method of claim 8, wherein the first TCI field indicates the at least one TCI state based at least in part on a first mapping table associated with the first subband, and the second TCI field indicates the second TCI state based at least in part on a second mapping table associated with the second subband.

10. The method of claim 1, wherein the BWP configuration indicates a first subset of the set of TCI states associated with the first subband and a second subset of the set of TCI states associated with the second subband.

11. The method of claim 10, further comprising:
receiving a message indicating an index, wherein the index indicates the first subset of the set of TCI states associated with the first subband; and
receiving a message indicating a bitmap, wherein one or more bits of the bitmap having a first value indicate one or more TCI states of the first subset of the set of TCI states that are active for communication via the first subband.

12. The method of claim 1, wherein the BWP configuration indicates a first subset of the set of CSI-RS resources associated with the first subband and a second subset of the set of CSI-RS resources associated with the second subband.

13. The method of claim 12, further comprising:
receiving a message indicating an index, wherein the index indicates the first subset of the set of CSI-RS resources associated with the first subband; and
receiving a message indicating a bitmap, wherein one or more bits of the bitmap having a first value indicate one or more CSI-RS resources of the first subset of the set of CSI-RS resources that are active for communication via the first subband.

14. The method of claim 1, wherein the BWP configuration indicates a set of CSI-RS resources valid for the second subband.

15. The method of claim 14, further comprising:
communicating with the network node in accordance with a subset of the set of CSI-RS resources valid for the second subband, the subset of the set of CSI-RS resources selected based at least in part on a size of the first subband.

16. The method of claim 1, wherein the BWP configuration indicates a first set of periodic CSI-RS resources valid for the first subband and a second set of periodic CSI-RS resources valid for the second subband.

17. The method of claim 1, wherein the second subband extends a full bandwidth of the BWP, and the first subband extends a portion of the full bandwidth.

18. A method of wireless communication performed by a network node, comprising:
transmitting, to a user equipment (UE), a bandwidth part (BWP) configuration that configures a BWP, the BWP including at least a first subband having a first set of resource blocks (RBs) and a second subband having a second set of RBs, wherein the BWP configuration is associated with a set of transmission configuration indication (TCI) states, a set of channel state information (CSI) reference signal (CSI-RS) resources, or both, valid for at least one of the first subband or the second subband;
transmitting, to the UE, a message activating the first subband for communications; and
communicating with the UE in accordance with at least one TCI state of the set of TCI states valid for the first subband or at least one CSI-RS resource of the set of CSI-RS resources valid for the first subband and the message activating the first subband.

19. The method of claim 18, further comprising:
transmitting, to the UE, a message indicating a first subset of the set of TCI states that is valid for the first subband and a second subset of the set of TCI states that is invalid for the first subband, wherein the first subset comprises the at least one TCI state valid for the first subband.

20. The method of claim 19, wherein the message includes a bitmap, one or more bits of the bitmap each having a first value or a second value, wherein a bit having the first value indicates a TCI state being valid for the first subband and a bit having the second value indicates a TCI state being invalid for the first subband.

21. The method of claim 18, further comprising:
transmitting a first downlink control information (DCI) message including a first TCI field indicating the at least one TCI state, wherein a size of the first TCI field is based at least in part on a number of TCI states of the set of TCI states that are valid for at least one of the first subband or the second subband.

22. The method of claim 21, wherein the first TCI field indicates at least one TCI state in accordance with a size of the first subband.

23. The method of claim 21, wherein the first TCI field includes zero padding based at least in part on a size of the first subband.

24. The method of claim 21, further comprising:
transmitting a message indicating the second subband for communications;
transmitting a second DCI message including a second TCI field indicating a second TCI state, wherein the second TCI field has a size equal to the size of the first TCI field; and
communicating with the UE in accordance with the second TCI state based at least in part on the second TCI field.

25. The method of claim 24, wherein the first TCI field indicates the at least one TCI state based at least in part on a first mapping table associated with the first subband, and the second TCI field indicates the second TCI state based at least in part on a second mapping table associated with the second subband.

26. The method of claim 18, wherein the BWP configuration indicates a first subset of the set of TCI states associated with the first subband and a second subset of the set of TCI states associated with the second subband.

27. The method of claim 26, further comprising:
transmitting a message indicating an index, wherein the index indicates the first subset of the set of TCI states associated with the first subband; and
transmitting a message indicating a bitmap, wherein one or more bits of the bitmap having a first value indicate one or more TCI states of the first subset of the set of TCI states that are active for communication via the first subband.

28. The method of claim 18, wherein the BWP configuration indicates a first subset of the set of CSI-RS resources associated with the first subband and a second subset of the set of CSI-RS resources associated with the second subband.

29. A user equipment (UE) for wireless communication, comprising:
one or more memories; and
one or more processors, coupled to the one or more memories, configured to cause the UE to:
receive, from a network node, a bandwidth part (BWP) configuration that configures a BWP, the BWP including at least a first subband having a first set of resource blocks (RBs) and a second subband having a second set of RBs, wherein the BWP configuration is associated with a set of transmission configuration indication (TCI) states, a set of channel state information reference signal (CSI-RS) resources, or both, valid for at least one of the first subband or the second subband;
receive, from the network node, a message activating the first subband for communications; and
communicate with the network node in accordance with at least one TCI state of the set of TCI states or at least one CSI-RS resource of the set of CSI-RS resources that are valid for the first subband and the message activating the first subband.

30. A network node for wireless communication, comprising:
one or more memories; and
one or more processors, coupled to the one or more memories, configured to cause the network node to:
transmit, to a user equipment (UE), a bandwidth part (BWP) configuration that configures a BWP, the BWP including at least a first subband having a first set of resource blocks (RBs) and a second subband having a second set of RBs, wherein the BWP configuration is associated with a set of transmission configuration indication (TCI) states, a set of channel state information reference signal (CSI-RS) resources, or both, valid for at least one of the first subband or the second subband;
transmit, to the UE, a message activating the first subband for communications; and
communicate with the UE in accordance with at least one TCI state of the set of TCI states valid for the first subband or at least one CSI-RS resource of the set of CSI-RS resources valid for the first subband and the message activating the first subband.
